(19) United States
(12) Patent Application Publication
(10) Pub. No.: US 2007/0288357 A1
(43) Pub. Date: Dec. 13, 2007

(54) Loan Simulation Method And System

(75) Inventors: Peter Holman, Carrara (AU); Craig Reiach, Nerang (AU); Brian Wood, Hamilton (NZ); Geoffrey Andrew Brieger, Tallai (AU); Gary Jan Veitch, Parkwood (AU)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ETRACKA PTY LTD., BUNDALL QLD 43217 AUSTRALIA (AU)

(21) Appl. No.: 11/568,800

(22) PCT Filed: May 6, 2005
(86) PCT No.: PCT/AU05/00650

§ 371 Date: Jun. 1, 2007

(30) Foreign Application Priority Data
May 7, 2004 (AU) 2004902413

(51) Int. Cl. G06F 17/00; G06Q 40/00

(52) U.S. Cl. 705/38

(57) ABSTRACT

A method (300) of simulating for a borrower the performance of a loan, which loan contains a plurality of loan portions wherein each loan portion has different loan parameters, which borrower may verify their identity (302) and enter/update borrower details (304) as required. The method includes the steps of: inputting income information (306) about income of the borrower; inputting asset information and liability information (308) about assets and liabilities of the borrower; inputting expenditure information (310) about expenditure of the borrower; inputting loan parameter information (314) about the amount, interest rate, repayment mode and term of each of said plurality of portions of the loan; providing assumptions about future market conditions effecting the loan; calculating a flow of funds (318) available for repayment of each portion of the loan according to the borrower income, the borrower expenditure, the borrower assets and liabilities, and the loan parameter information and producing a simulation of loan balance according to the flow of funds and the assumptions about future market conditions, for display and/or printing (320). An on-line subscriber system (100) and application software (200) enabling users to conduct assessment and ongoing management of loans and similar finance products according to the method are also disclosed.

### CROSS-REFERENCE TO RELATED APPLICATIONS

This application claims the benefit of Australian Provisional Patent Application No. 2004902413 filed by the present applicant on 7 May 2004.

### BACKGROUND OF THE INVENTION

1. Field of the Invention

The present invention relates to methods for assessing the comparative performance of loans, including lines of credit, redraw loans, term loans with offset accounts that work in conjunction with the term loans, and similar finance products that contain loan portions having different loan parameters.

In particular, although not exclusively, the invention relates to methods of simulating the future performance of a loan structure that includes a transactional loan according to a strategy that includes anticipated loan repayments from estimated and/or actual income with interest calculations based on a user's estimated and actual expenditure profiles.

The invention is also related to a subscriber system for enabling users, such as loan customers (“Customer Members”) and financial services agents (“Loan-Writer Users”), to conduct assessment and ongoing management of such finance products on behalf of their clients.

2. Discussion of the Background Art

It is widely accepted that a home loan, typically secured by mortgage over the property, is the largest single financial commitment that individuals or families make either during their working life or in retirement. Efficient management of finances has the potential to liberate substantial savings in interest and other fees and charges imposed by financial institutions. However, many home loan schemes contain a plethora of terms and conditions which must be balanced against available income, living expenses and discretionary spending, which by their nature are generally quite fluid.

Accordingly it would be desirable to provide a system for assessing the future performance of loan products against a flexible set of assumptions, which could also be employed by individuals and families to actively manage finances with the aim of reducing the term of their loans where possible.

### SUMMARY OF THE INVENTION

### Object of the Invention

It is an object of the present invention to provide an improved system and method for assessing future performance of loan products.

It would be particularly advantageous, if an embodiment of the invention provided an automated system having tools for managing a loan which has portions with differing parameters, including split between fixed and variable interest portions and/or principal with interest and interest only portions, whereby the effect of a borrower's spending and investment decisions on repayment progress of a transactional loan may be conveniently simulated.

### DISCLOSURE OF THE INVENTION

In a first broad aspect the present invention provides a method of simulating for a borrower the performance of a loan, which loan contains a plurality of loan portions wherein each loan portion has different loan parameters, the method including the steps of:
inputting income information about income of the borrower;
inputting expenditure information about expenditure of the borrower;
inputting asset and liability information about assets and liabilities of the borrower;
inputting loan parameter information about the amount, interest rate, repayment mode, and term of each of said plurality of portions of the loan;
providing assumptions about future market conditions effecting the loan;
calculating a flow of funds available for repayment of each portion of the loan according to the borrower income, the borrower expenditure, the borrower assets and liabilities, and the loan parameter information; and
producing a simulation of loan balance according to the flow of funds and the assumptions about future market conditions.

In a second broad aspect the present invention provides a method of managing for a plurality of borrowers the performance of loans to a borrower wherein at least one loan contains a plurality of loan portions, each loan portion having different loan parameters, the method including the steps of:
inputting income information about income of each borrower;
inputting expenditure information about expenditure of each borrower;
inputting asset and liability information about assets and liabilities of each borrower;
inputting loan parameter information about the amount, interest rate, repayment mode and term of each of said plurality of portions of said at least one loan;
providing assumptions about future market conditions effecting the loans;
calculating a flow of funds available for repayment of each portion of the respective loans according to the borrower income, the borrower expenditure, the borrower assets and liabilities and the loan parameter information; and
producing for each borrower a simulation of loan balance according to the flow of funds and the assumptions about future market conditions.

Suitably each loan portion may comprise a plurality of loan segments relating to the temporal sequence of the loan portion, which portion is preferably a portion of the amount of said loan.

The step of inputting income information may include inputting after tax wage or salary income, rental income, dividend income and tax refunds, both fixed and diminishing, together with the frequency of each income category.

The step of inputting asset and liability information desirably includes information about pre-existing loans and repayments relating to the liabilities of the borrower. The step of inputting asset and liability information may further include inputting information about a home, investment properties, other investments (such as shares, bonds, precious metals, gemstones and art works), motor vehicles, personal/other loans, credit cards and cash.

The step of inputting asset and liability information may further include inputting security information about security provided for the loan. The security information may include a valuation of the security over which a mortgage or charge is held to secure the loan.

The step of inputting expenditure information may include inputting cash expenditure, home expenditure, utility expenditure, food/healthcare expenditure, personal expenditure, clothing/footwear expenditure, and motor vehicle expenditure.

The step of inputting loan information may include inputting a lender, type of loan product, the interest rate of the loan product, and the maximum loan-to-value (LTV) ratio. The type of loan product may include an interest only/fixed credit limit type and/or an amortizing credit limit type of loan. The step of inputting loan information may include inputting information about a proposed transactional loan for the purposes of comparison.

The step of inputting loan information preferably involves the precedent step of setting up portions of the loan and the temporal segments of the loan portions with respective loan parameters.

The step of setting up said loan portions suitably includes inputting the portion amounts, the debt to be allocated to each portion and the tax-deductibility treatment of each portion.

The step of setting up the segments of the portions suitably includes inputting the interest rates, whether the interest rates are fixed and/or variable interest rates, and the term of each segment of the portion.

If required, the method may further include the subsequent step of calculating the maximum available loan amount on the basis of the total value of security to be used multiplied by the maximum loan-to-value ratio, and displaying said maximum available loan amount.

The step of inputting assumptions about future market conditions affecting the loan may include inputting variations in interest rates applicable to said variable interest rate portions or segments of the loan. The future market conditions may further include movements in property valuations, preferably whether values may be assumed to decrease, remain static or increase over the term of the loan.

Suitably the step of calculating the flow of funds includes the steps of:
a) nominating a desired loan portion as the primary account;
b) nominating the next loan portion in sequence as the primary account if the desired loan portion has a nil redraw capacity;
c) crediting income and revenue to the primary account;
d) debiting expenses from the primary account;
e) redrawing funds from the primary account and crediting other specified loan accounts;
f) repeating steps b) to e) for next credit/debit period unless all other specified loan accounts have nil balance.

Preferably the step of producing a simulation of the loan balance according to the flow of funds includes displaying to the borrower:
a graph depicting the loan balance at intervals throughout the term of the loan; or
a table demonstrating the loan balance of the loan per year or per transaction until a loan balance of nil is attained.

Suitably the step of simulating the loan balance includes calculation of loan credit and available loan credit potential.

Where the loan is a transactional loan, the simulation may include producing available loan credit according to the flow of funds, which further includes the step of producing a table demonstrating the available credit and the potential loan credit available per year for the transactional loan.

Preferably, the transactional loan is a home loan account.

If required, a number of simulations may be conducted sequentially in order to facilitate direct comparison between two or more loans according to broadly comparable sets of information and assumptions.

Most preferably, the present invention provides a method of simulating for a borrower or borrowers the performance of a transactional loan in accordance with a predetermined strategy, which transactional loan may contain multiple fixed interest rate portions and variable interest rate portions and each portion may contain multiple temporal loan segments, the method including the steps of:
inputting income information about income of the borrower;
inputting expenditure information about expenditure of the borrower;
inputting asset and liability information about assets and liabilities of the borrower, including existing loans and associated repayments relating to the liabilities of the borrower;
inputting transactional loan information proposed for refinancing of existing loans, including amount, interest rate, repayment mode and term of each portion and/or segment of the said transactional loan;
providing assumptions about future market conditions affecting the loans;
calculating a flow of funds available for repayment of each portion of the transactional loan according to the borrower income, the borrower expenditure, the borrower assets and liabilities, and the transactional loan information; and
producing a simulation of interest and years saved by said refinancing including available loan credit and available loan credit potential according to the flow of funds and the assumptions about future market conditions.

In another broad form of the invention, there is provided a computer readable medium carrying instructions for executing the loan simulation method stated above.

In a third broad aspect of the invention there is provided an on-line subscriber system for enabling users to conduct assessment and ongoing management of loans or similar finance products, said system including:

a service centre accessible via a public communications network, the service centre including processor means for executing a service software application, storage means for storing the service software application and client data, and communications interface means;

at least one client software application for execution by a remote client device for accessing the service centre via the public communications network; and

whereby upon verification of the identity of a Customer Member by the service centre, the client software application and the service centre software application interoperate to implement the method of simulating for the Customer Member the performance of a loan which contains a plurality of portions having different parameters, as set out hereinabove.

The loan parameters include amount, interest rate, repayment mode and/or term of the loan. The loan may contain at least one fixed interest rate portion and/or at least one variable interest rate portion.

In a fourth broad aspect of the invention, there is provided a service software application for a service centre of an on-line subscriber system enabling users to conduct assessment and ongoing management of loans or similar finance products, said software application including:

a master control module for administering records of subscribers and for configuration of member interfaces and a customer interface to a customer web site;

a loan-writer member control module for controlling a loan-writer interface in a loan-writer/lender web site;

a lender member control module for controlling a lender interface in the loan-writer/lender web site and a member information store, the lender interface providing access to information in a loan products information store; and

a simulator module for executing a loan simulation method stated above, utilising loan parameters entered via the member or customer interfaces.

In this specification the expression “transactional loan account” is meant to encompass loan accounts of the type linking a loan facility to a credit card facility wherein a borrower's income is deposited into the account, expenses are debited against the credit card facility which is periodically settled from funds held in the loan account, and interest is periodically calculated (for example daily) on the current balance of the loan account and charged in arrears (for example monthly in arrears).

The use of terms such as “borrower” or “Customer Member”, in the singular is not meant to exclude the possibility of loans held and/or serviced by joint or several borrowers or membership of the on-line subscriber system by joint or several Customer Members, respectively.

### BRIEF DETAILS OF THE DRAWINGS AND TABLES

In order that this invention may be more readily understood and put into practical effect, reference will now be made to the accompanying drawings that illustrate preferred embodiments of the invention, and wherein:

FIG. 1 is an overview diagram of an on-line loan simulation and management system of a first embodiment of the invention;

FIG. 2 is a diagram illustrating functional modules of the on-line loan simulation and management system of the first embodiment;

FIG. 3 is a flow-chart illustrating a method for on-line loan simulation as implemented by the system of the first embodiment;

FIG. 4 is a representation of a first user interface screen including a form for inputting borrower details and income information;

FIG. 5 is a representation of a third user interface screen including a form summarising information about the borrower's assets and liabilities information about the borrower's assets and liabilities

FIG. 5A is a representation of further form from the third user interface for inputting (or “setting up”) the information about the borrower's assets and liabilities;

FIG. 5B is a representation of further form from the third user interface for inputting the information about the borrower's assets and liabilities;

FIG. 6 is a representation of a second user interface including a form for inputting expense information;

FIG. 7 is a representation of a fourth user interface including a form for inputting assumptions about the state of the market;

FIG. 7A is a representation of a further form from the fourth user interface including a form for inputting or setting-up information about combination loan products;

FIG. 8 is a representation of a fifth user interface screen including a simulation display window;

FIG. 9 is a representation of a sixth user interface including a form for inputting expense information;

FIG. 9A is a representation of a form from the sixth user interface screen including a spread sheet display for setting up expense details;

FIG. 9B is a representation of a form from the sixth user interface screen for editing expense information;

FIG. 10 is a flow chart illustrating functional details of calculating the loan balance simulation of one embodiment of the invention;

FIG. 11 is a flow chart illustrating a surplus/deficit calculation procedure of a further embodiment;

FIGS. 12A and 12B contain a flow chart illustrating transactional loan calculation procedures of the further embodiment; and

FIG. 13 is a flow chart illustrating a traditional home loan calculation procedures of the further embodiment.

As a further aid to the understanding of the invention, there are also annexed to the specification tables which provide an overview of certain functional modules and associated user interface screens of the preferred embodiments, as follows:

Table 1A describes aspects of the customer web site (www.etracka.com);

Table 1B overviews the download procedure for the client management application software, referred to as the etracka “Pro” module;

Table 2 overviews the ancillary functional module, which includes the loan (or mortgage) simulator software;

Table 3 describes the operation of the down-loadable etracka “Pro” software, subsequent to down-load by loan-writer or lender members;

Table 4 describes the operation of the on-line loan simulation and management system, referred to as the etracka “Service” or “Simulator”;

Table 5 overviews features of the master control which is operable by the system administrator; and

Tables 6A and 6B sets out the preferred administrator controls for each of the lender members and loan writer members.

### DESCRIPTION OF EMBODIMENTS OF THE INVENTION

A first embodiment of the present invention resides in an on-line loan simulation and management system 100 providing a service that is independent from financial institutions, which system allows users to remotely manage their respective transactional home loan accounts. In particular, the system of the embodiment provides tools (such as the etracka “Service”/“Simulator”) enabling users, such as borrower members 101, 102, 103, (also referred to as customers or clients) to implement a loan reduction strategy. The first embodiment also includes a system administrator 130, whose role will be described below. Non-member users 104 can also review promotional material about the system which is freely accessible via a web site, also described below (see also Tables 1A and 4).

In other embodiments of the invention further categories of membership are also provided, including Loan-writer members 110 such as financial advisors, financial service agents and mortgage brokers who typically provide independent financial advice to borrowers. Loan-writer members may use the service as a proxy for their clients and/or may download additional software (such as the etracka “Pro” module—see also Tables 1B and 3) which enables creation of client files for upload to the loan simulation and management system for direct remote access by clients. A further embodiment of the invention may also include Lender members 120, such as banks, credit unions and other financial institutions, who are able to provide a co-branded loan simulation and management service to their own customers.

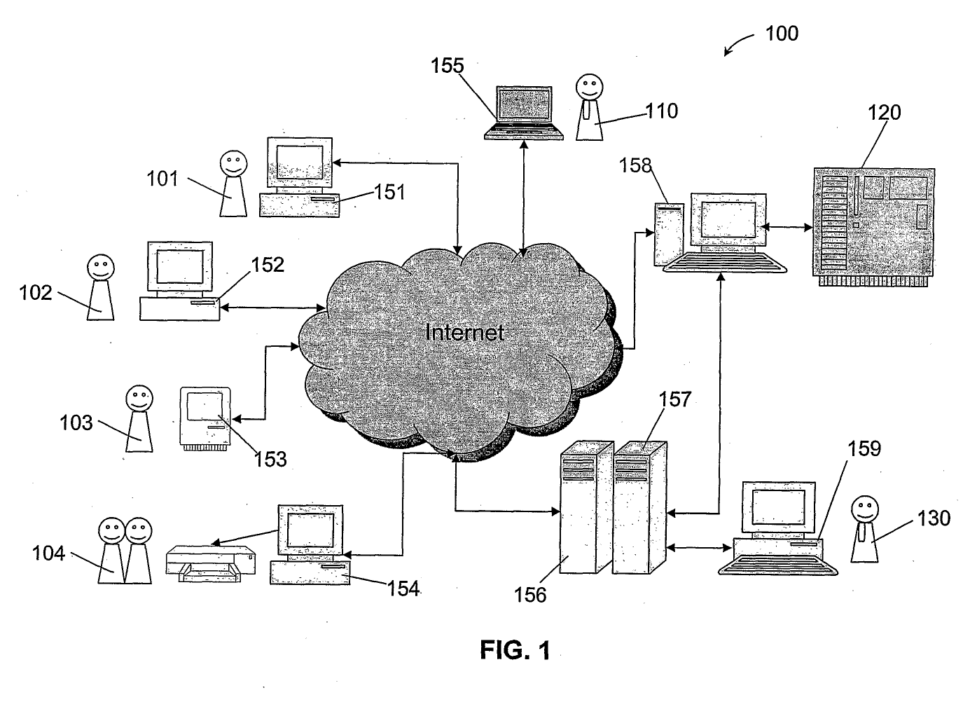

The system 100 of the embodiment may be considered with regard to a distributed computing public network environment, such as the Internet, as depicted in FIG. 1. Here a number of computing devices, such as personal computers (PCs) 151, 152, 153, 154, laptop computers 155 and personal digital assistants (PDAs), servers including Internet servers 156, database servers 157 and mainframe gateway servers 158, may communicate with one another utilising the public telecommunications infrastructure and/or private communications links or a combination of these arrangements.

In the system of the embodiment, computing devices provided for enabling the service and the web site include the web server 156 and the database server 157 which are configured and managed by the system administrator 130. The system administrator has a role in managing database records and access rights for each category of member via a master control module (see also Table 5), some of which roles are delegated to the Loan-writer and Lender members as desired.

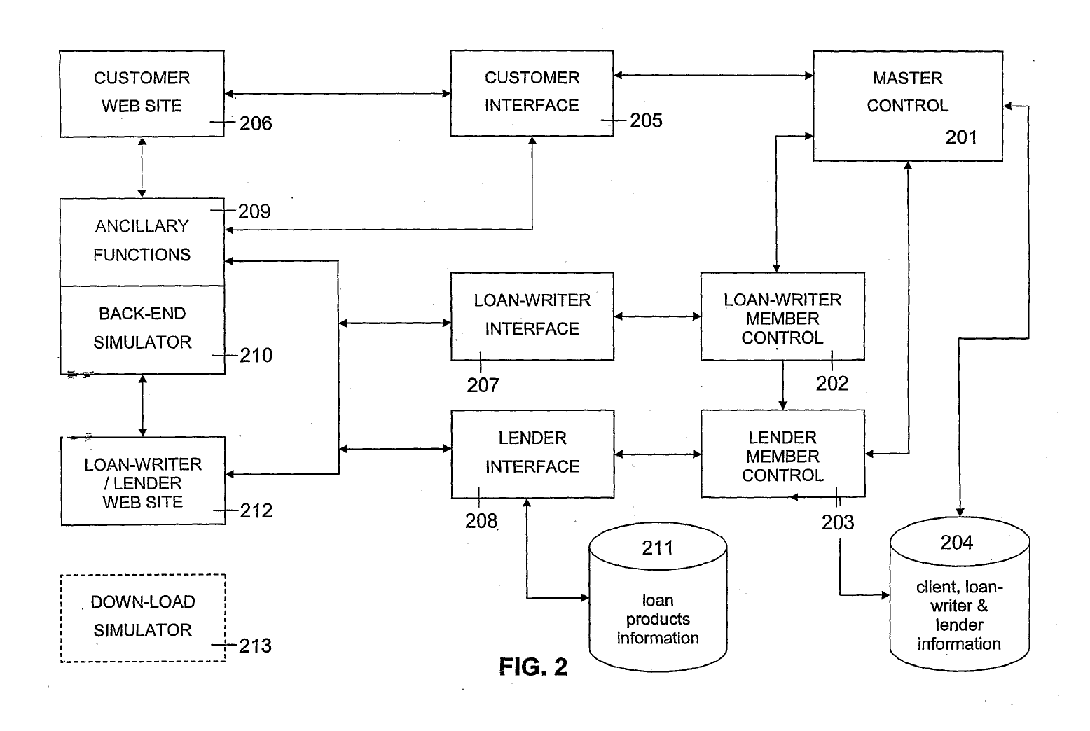

Turning now to FIG. 2, there is shown a number of functional program modules of the system 200, including a master control module 201 which is accessed by the system administrator 130. The master control 201 provides functions to administer records of Lender members 120 and of Loan-writer members 110, and to configure the respective Loan-writer member control 202 and Lender member control 203 modules. The system administrator 130 utilises a network computer 159 to access the Internet 156 and database server 157 for these purposes, including maintenance of member information records that are stored in a member information store 204 provided by the database server.

The master control 201 also provides for configuration of a customer interface module 205 and web site 206. Further details about the preferred customer member web site are set out in Table 1A. Similarly there is a loan-writer interface module 207 and a lender interface module 208, which are operated in accordance with their respective loan-write and lender control modules 202 and 203. The interfaces are manifest on a loan-writer/lender web site 212, to which these classes of members are authorised to access. These interfaces also provide for download and registration of the etracka “Pro” software, as described in Table 1B, which facilitates the local creation and management of client files, which client files may be subsequently uploaded to the client database in member information store 204.

The ancillary functions module 209 provides file maintenance functions, printing functions (including printing of reports and printing currently open screen interface window), client management functions (including client search and recall for loan-writer members and lender members). An auxiliary loan calculator allows users to determine loan repayments and/or terms for principal and interest (P&I) and interest only (IO) type loans.

The closely associated back-end loan simulator module 210 provides for simulation of the balance of the customers overall financial position, on the basis of input of financial information and certain market assumptions, as will be further described below. The down-loaded etracka “Pro” software also includes a down-load simulator module 213 which provides for local sub-function simulation of loans on a loan-writer computer 155. In relation to the back-end simulator of the preferred embodiment, a transactional home loan refers to any mortgage loan product whereby:
interest is calculated on the daily loan balance and charged monthly in arrears;
income and revenue may be credited directly into the loan account at any time (or into an offset account);
redraw from the loan account is available up to an agreed “Credit Limit”, which may be the amortization schedule of a term loan (or redraw is available from an offset account); and
the loan account (or offset account) is a fully transactional facility whereby the account-holder may transact frequently within the credit limit via automatic teller machine and/or cheque and/or Internet banking or bill payment service and/or telephone banking or bill payment service.
   A credit card is assumed to refer to any credit or charge card account whereby an interest free period is provided so that no interest is payable if the closing balance of the account (as at the statement date) is paid in full by the due date. Furthermore an offset account means any transactional deposit account whereby:
the transactional deposit account operates in conjunction with a secured loan product; and
the transactional deposit account has the equivalent interest rate to that of the secured loan product and operates in such a way that the interest payable on the secured loan product is reduced by the amount of the interest that would have been paid on the transactional deposit account.
   These assumptions are stated for ease of understanding of the description of the preferred embodiment and it will be appreciated that other account types may be suited to alternative embodiments of the present invention.

It should be noted that Customer Members may be registered with the system of the embodiment in any one of three (3) ways:
(i) direct registration by payment of a registration fee by the user 101 via the customer web site 206;
(ii) indirect registration by a Loan-Writer member 110 (who may have previously down-loaded the etracka “Pro” software or created it on-line) entering the relevant information and enabling access for users 102, 103; and
(iii) indirect registration of a user 104 by a Lender member (such as a financial institution 120) or by the system administrator 130.

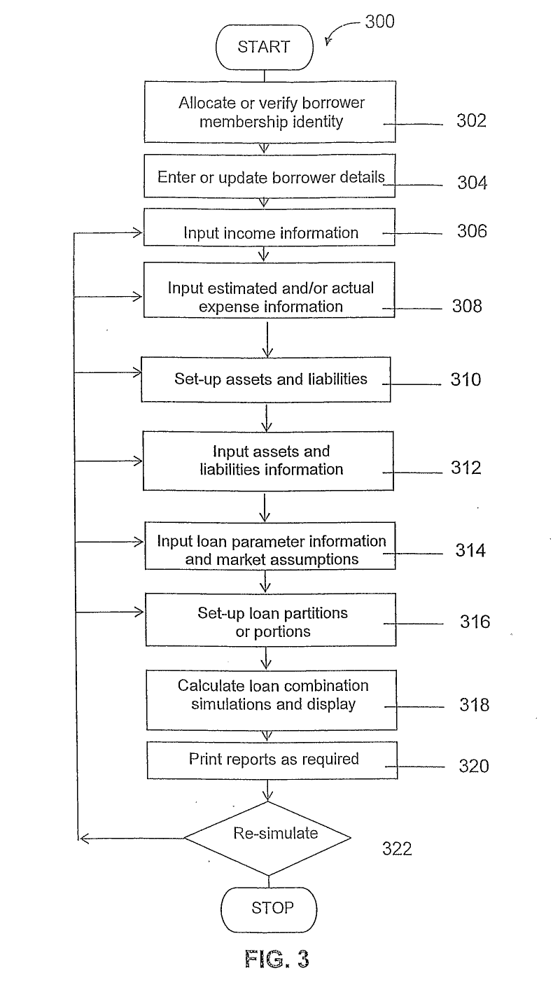

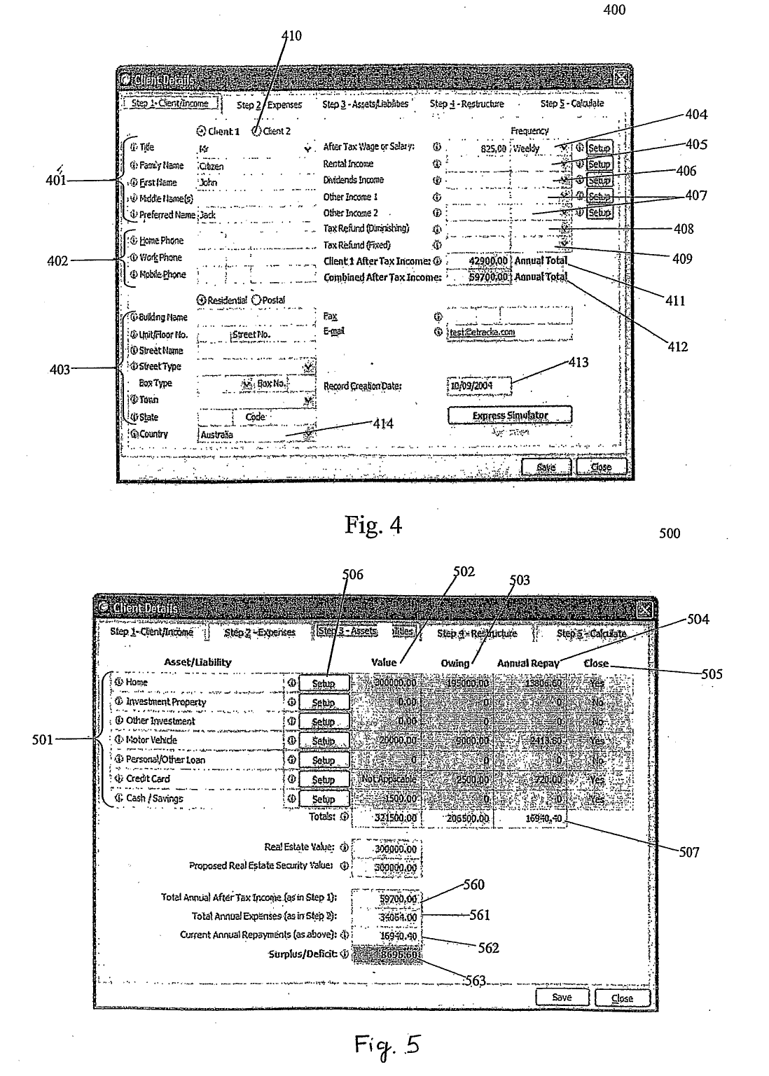

Referring to FIG. 3, there is shown a flowchart illustrating a method 300 for on-line loan simulation and comparison, wherein in step 302 the client/borrower or Customer Member identity number is allocated or verified if allocated in an earlier session. Table 4 also provides an overview of each of the five main steps, denoted Steps 1 to 5, of the etracka service or loan simulator. In step 304 client or borrower details are either entered or updated using a first user interface screen input form 400 as illustrated in FIG. 4. In general terms the layout of the user interface screens employs a tabbed paradigm (see top edge of the screen), wherein users may navigate amongst different tabs identifying the main functional steps, including the ‘Client/Income’ form for ‘Step 1’ as depicted in FIG. 4.

The Customer Member or client details for input include sets of fields for client identity details 401, client contact details 402 and client address details 403. In step 306 of method 300, the client or borrower income information is input. Referring to input form 400, the client income information includes amount and frequency fields for each of after tax wage or salary 404, rental income 405, dividend income 406, other income 407, tax refund (diminishing) 408 and tax refund (fixed) 409. The frequency filed refers to the frequency with which the income is credited to the transactional home loan account.

The first user interface screen also displays calculated fields for borrower or Customer Member verification purposes. Calculated fields are provided for each of ‘annual after tax income’ 411 and, where a second client is contributing to servicing a loan, such as in a dual income family household (see radio button 410 for “Client 2”), for ‘combined after tax income’ 412. A record creation date entry field 413 is generated for audit purposes, and a country of origin pull-down menu 414 allows selection of country—to facilitate switching the idiom and/or language of the field descriptors to one appropriate to the selection.

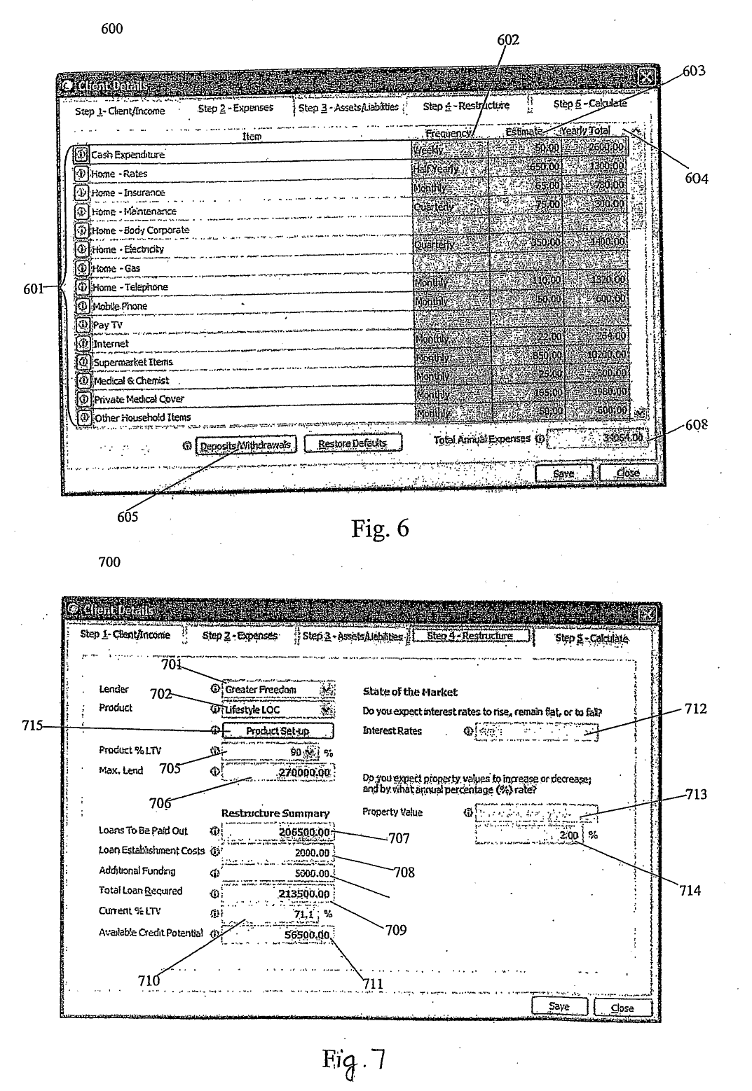

The next step in flow chart 300 is to input the estimated and actual expense information for the borrower in step 308 of FIG. 3. A third user interface screen input form 600 accessible from the ‘Step 2—Expenses’ tab is depicted in FIG. 6. Expense items 601, which are listed in the left-most column of form 600, include cash expenditure, home: rates, insurance, maintenance, dues/body corporate, utilities: electricity, gas and telephone, mobile phone, pay TV, internet, food/healthcare: supermarket, pharmacy, health insurance, personal: hair cuts/treatments, clothing/footwear, and motor vehicles.

The categories of expense items may be listed with menu-headers tailored by country to effect term neutralisation. The client user may create additional categories (and apply an item description) as desired. For each expense item, payment frequency may be identified as weekly, twice-weekly, fortnightly, monthly, quarterly, half-yearly or yearly, as appropriate in column 602. The estimated (or actual) amount expended on each expense item is entered at the frequency selected in a respective field of column 603.

The yearly totals for each item of expenditure is calculated and displayed in respective ‘Yearly Total’ fields in column 604, with the ‘Total Annual Expenses’ being tallied at 608. Any lump sum deposits and/or withdrawals may be included at any given month by the “DepositNVithdrawal” button 605.

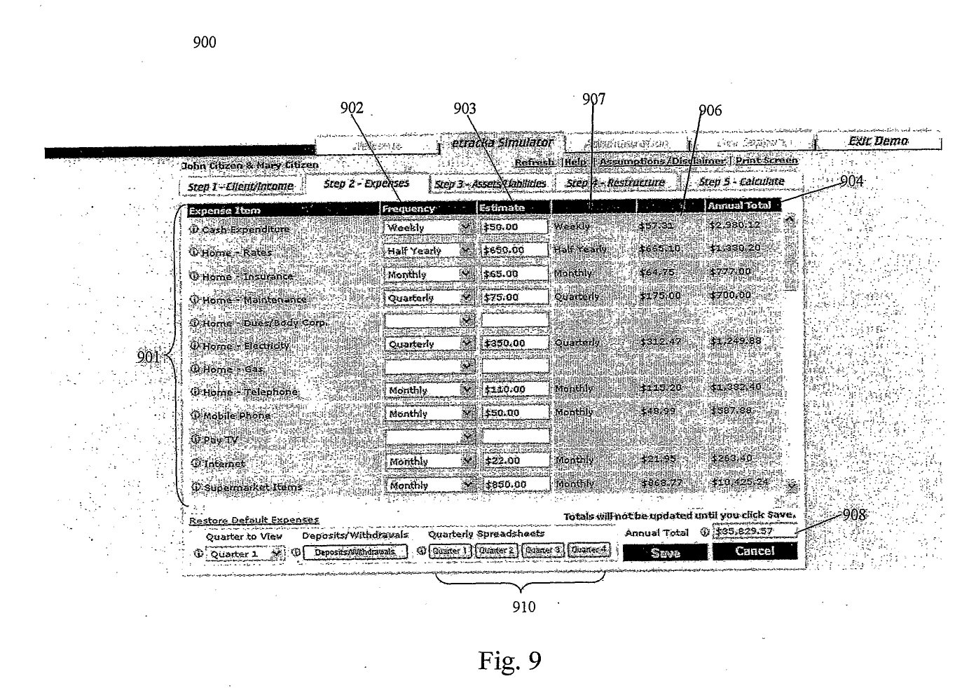

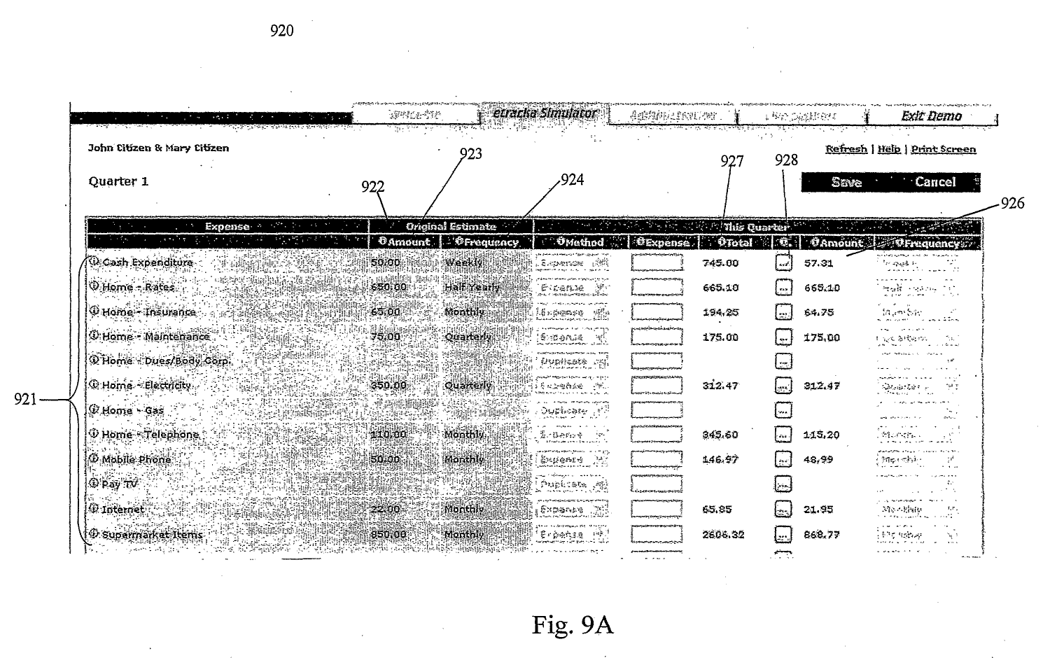

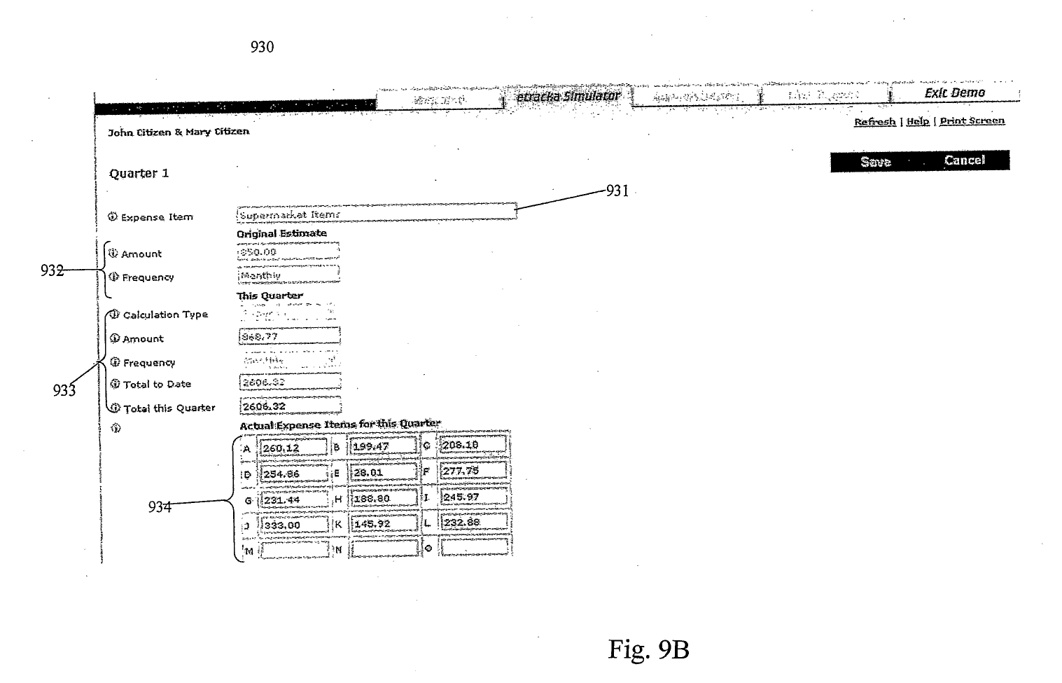

Underlying detailed expense data for comparison with the projected estimates for each item may be input on the quarterly ‘Spreadsheets’ by activating a respective button 910 see FIG. 9. It should be noted that this function is only available in the present online service embodiment of the invention which includes the back-end simulator 210, meaning that this function is not present in the down-load simulator 213 provided with the downloadable software designated the etracka “Pro”. However, an alternative embodiment of the “Pro” software, which is overviewed in Table 3, links the fully functional simulator.

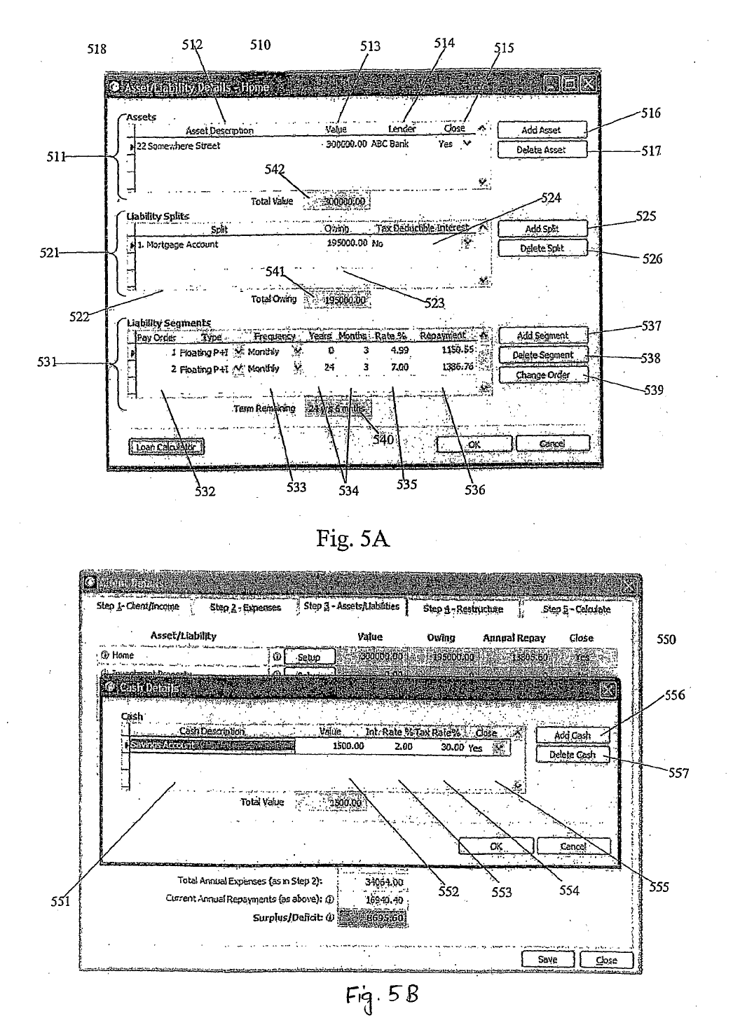

Returning to the flow chart 300 in FIG. 3, the next step is the set-up of assets and liabilities information in step 310. A third user interface screen for the ‘Step 3-Assets/Liabilities’ tab is depicted in FIG. 5. The screen 500 includes a summary of information about the borrower's assets and liabilities, listing items 501 such as home(s), investment properties, motor vehicles, personal/other loans and credit cards together with respective fields for value 502, amount owing 503, annual repayments 504 and close/link status 505 information for each item. The close/link status 505 identifies whether an asset and its associated liabilities are to be included in the simulated balance calculation (described below). The display of a “partly” status (not shown) in an asset row indicates that only a part of the assets and liabilities listed in the asset category have been identified to be closed. A total amount 506 is also calculated for each of the value, amount owing and annual repayment columns.

The step of inputting asset and liability information includes the input of factual or projected information about pre-existing loans and repayments which comprise or relate to the liabilities of the borrower. This information is entered via a set-up interface form, which may be accessed via the buttons 506 adjacent each asset/liability item. The set-up form, as exemplified in FIG. 5A, allows an asset description and information about the value of asset, the lender of any liability associated with the asset and close status to be input and/or edited. An example of a set-up form 510 for ‘Home(s)’ is shown in FIG. 5A, which form includes three tables and associated operations buttons, namely the ‘Assets’ table 511, the ‘Splits’ table 521, and the ‘Split Segments’ table 531.

The assets table 511 includes columns for input of each of asset description 512, value 513, lender 514 and a close flag 515, together with an ‘Add Asset’ operating button 516 and a corresponding ‘Delete Asset’ button 517.

The splits table 521 includes columns for input of each of a split identifier 522, amount owing 523 and a flag 524 indicating tax deductibility. The term “split” is here used to identify liability splits in the form of loan portions having different repayment regimes, for example principle & interest, fixed or floating rate; interest only fixed or floating interest rate, frequency of repayment (eg. monthly). The information about loan splits may be added and deleted using the respective ‘Add Split’ operating button 525 and ‘Delete Split’ button 526.

The final table in the set-up form 510 is for loan segments, i.e. temporal portions of a loan having a particular payment regime wherein (typically) the interest rate changes, for example from an introductory period of a year, together with the duration of the segment years/months and applicable interest rate. The Split Segments table 531 includes columns for pay order 532, segment type(ref), frequency 533 (of repayment), duration 534 (in years and months), interest rate 535, and repayment 536 (amount). Control buttons are also provided for add segment 537, delete segment and change order 539 (of repayment). Finally the auxiliary set-up form 510 includes windows displaying calculated values for total loan term 540, total owing 541 and total value 542 (of assets).

A further set-up form is illustrated in FIG. 5B, as discussed above such a set-up form is accessed via buttons 506 adjacent each asset/liability item in this case the cash/savings item. The form 550 includes columns for input of a description for each asset 551, value 552, interest rate 553, tax rate 554 and a close flag 555, together with an ‘Add Cash’ operating button 556 and a corresponding ‘Delete Cash’ button 557.

Returning to FIG. 5 the sum of ‘Total Annual after Tax Income (as in Step 1)’ is displayed in field 560 less the current “Total Annual Repayments (as in Step 3)” as displayed in field 561 and ‘Total Annual Expenses (as above, i.e. Step 2)’ at 562 provides a ‘Surplus/Deficit’ result which is displayed in field 563. Any Surplus result, for example the surplus 563 depicted in FIG. 5, is applied to a Cash Accrual Account and is taxed annually in arrears at a reate assumed or set-up in the form illustrated in FIG. 5B discussed above. With reference to FIG. 9, there is depicted an example a form for inputting expense information 900, actual expenditure for each quarter 1 to 4 may be calculated and totalled with respect to frequency. This calculation provides for a comparison between the original expense item estimates and the actual expense for each quarter. The form 900 includes columns for each expense item 901, respective estimates 903 with frequency 902, actual expenditure 906 and annual total expenditure 904 with revised frequency 907, and an indication of the total annual expense displayed at 908. The entries in column 906 may be freely entered and/or updated via accessing the quarterly spreadsheets by clicking the respective quarter buttons 910.

FIG. 9A depicts one possible lay out of a quarterly spreadsheet in this instance for the ‘First Quarter’. The spreadsheet 920 includes a description of each expense item 921, original estimates 922 including the amount 923 and frequency 924, the actual amount of expenditure on each item 926 and the total amount of expenditure on each item for the selected quarter 927. The entries in column 926 for each expense item may be free amended by activating adjacent buttons 928 this brings up form 930 shown in FIG. 9B.

Form 930 includes a description of the selected expense item 931, information regarding the original expense estimate for the selected item 932 including the frequency and a summary of the expenditure on the item for the quarter including the current level of expenditure ‘amount’. The current actual amount of expenditure on the selected item may be alter by entering the appropriate value in the expense item fields 934.

It should be noted that only a single entry per quarter is permitted for quarterly expense items, two entries per (4) quarters are permitted for half-yearly expenses; and a single entry per four (4) quarters is permitted for yearly expenses—as the grey areas of the sheet are not accessible.

The spreadsheets are established with self-calculating worksheets enabling actual expense details to be entered and calculated with respect to each expense item on a cumulative basis from Quarter 1 to Quarter 4 of the current financial year. Where no actual expense details are entered into a line that relates to an expense item, the originally estimated expense is assumed and noted as ‘Duplicate’. This function continues after ‘Quarter 1’, but uses entered spreadsheet data in priority to any originally estimates, for example ‘Quarter 2’ duplicates expense patterns from ‘Quarter 1’, not from the original estimate. Where “No Expense” is selected and no expense details are entered into the spreadsheet, the originally estimated expense is overwritten as being ‘Nil’.

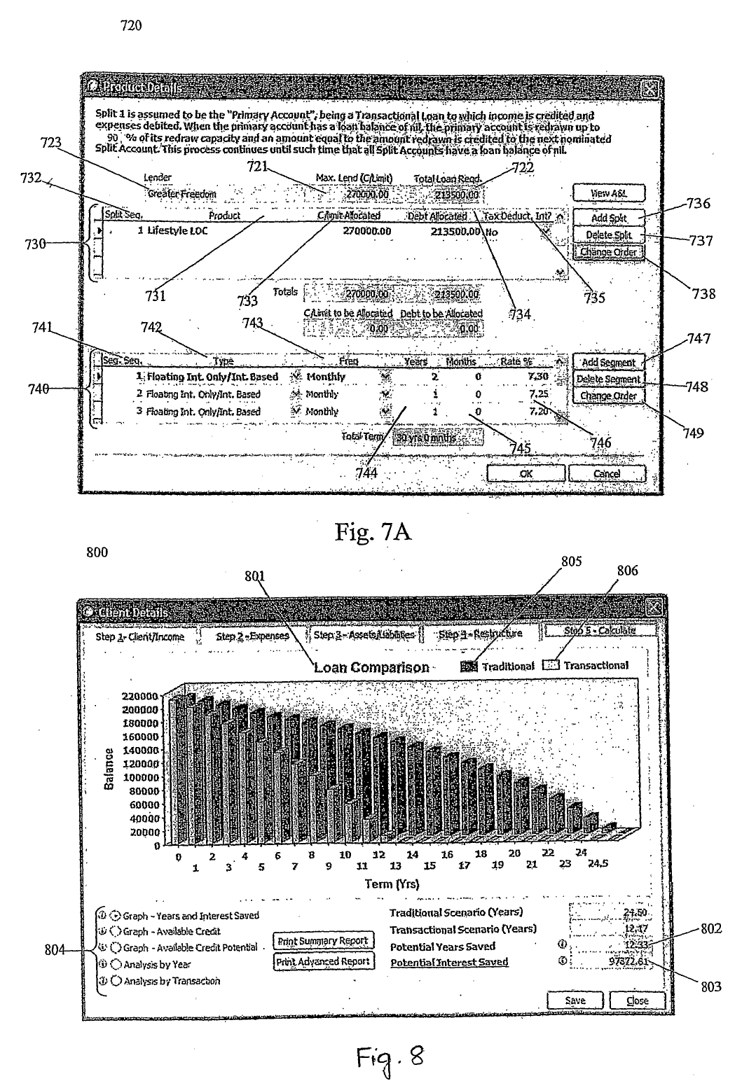

With reference to FIG. 3, the next step is the input of loan information and market assumptions 314, which is accessible from ‘Step 4—Restructure’ as depicted in the user interface input form 700 illustrated in FIG. 7. The input form 700 allows for input of loan information, providing fields for selection of lender 701 from available lender members or from a generic other category of lender (which may be created by the client user) and the type of loan product 702, for example depending on whether the product is of an interest only/fixed credit limit (‘IO Limit’) type or to an amortizing credit limit (‘Am Limit’), with the redraw capacity being dependent upon the type of loan selected. The maximum loan-to-value (LTV) ratio of the product is selected from pull-down menu 705. The maximum available lend amount displayed in field 706 is calculated on the basis of the total value of real estate and other assets to be used as security multiplied by the maximum loan-to-value ratio of the loan product selected.

In the refinancing or loan restructuring scenario (as identified in Step 3—Assets/Liabilities form 500 by the Close parameter in column 505 of FIG. 5) field 707 shows the amount of the existing loan(s) to be paid out, user input of loan establishment costs is enabled in field 708, and the total loan required (summing fields 707, 708 and optionally allowing for additional funding 916) in field 709. The current ‘Loan to Value’ ratio shown in field 710 is calculated as the ‘Total Loan Required’ 709 divided by the total value of real estate assets to be used as security in the refinance (described below). The available credit following refinancing is indicated in field 711 and calculated as the ‘Maximum Lend’ 706 less the ‘Total Loan Required’ 709.

The market or restructure assumptions affecting the future conduct of the loan, may then be input by the user. The assumptions are first as to whether interest rates will rise, remain flat or fall is input via pull-down menu 712. The second assumptions are as to whether property values will increase or decrease and secondly by what annual rate, is input via pull-down menu 713 and field 714 respectively.

The next step of the method in flowchart 300 is to set-up the loan partitions or portions in step 316. This is achieved accessing from ‘Product Set-up’ button 715, a further form from the fourth user interface, as illustrated in FIG. 7A. The further form entitled ‘Product Details’ for inputting or setting-up information about combination loan products. Three display windows with lender information 723 amounts for maximum loan 721 and total loan required 722 appear near the top of the form. There is an assumption stated on the form 720 that Split-Loan Account 1 (the “Primary Account”) is assumed to be a transactional loan account (as defined herein).

The form includes two tables, the first upper table 730 listing the loan splits, with columns for each of loan product 731, sequence or order 732, credit limit/allocated amount 733, debt allocated 734 (to split loan accounts) and tax deductibility 735. There are also control buttons for adding a split 736, deleting a split 737 or changing the order 738. When the Primary Account has a loan balance of nil, the Primary Account is redrawn up to a percentage of its redraw capacity as nominated by the user and an amount equal to the amount redrawn from the Primary Account is credited to another loan account as nominated by the user in accordance with the pay order/sequenced in table 730.

The second table 740 indicates the repayment sequence of any loan segments applicable to respective loan splits, with columns for each of pay sequence 741, type 742, repayment frequency 743, repayment duration in years 744 and months 745 and the interest rate (%) 746. Control buttons are provided to add segment 747, delete segment 748 and change order 749 (of payment application). This arrangement is highly flexible since it allows for many different combinations of loan accounts (or splits) including different loan combinations and temporal segments within each loan account.

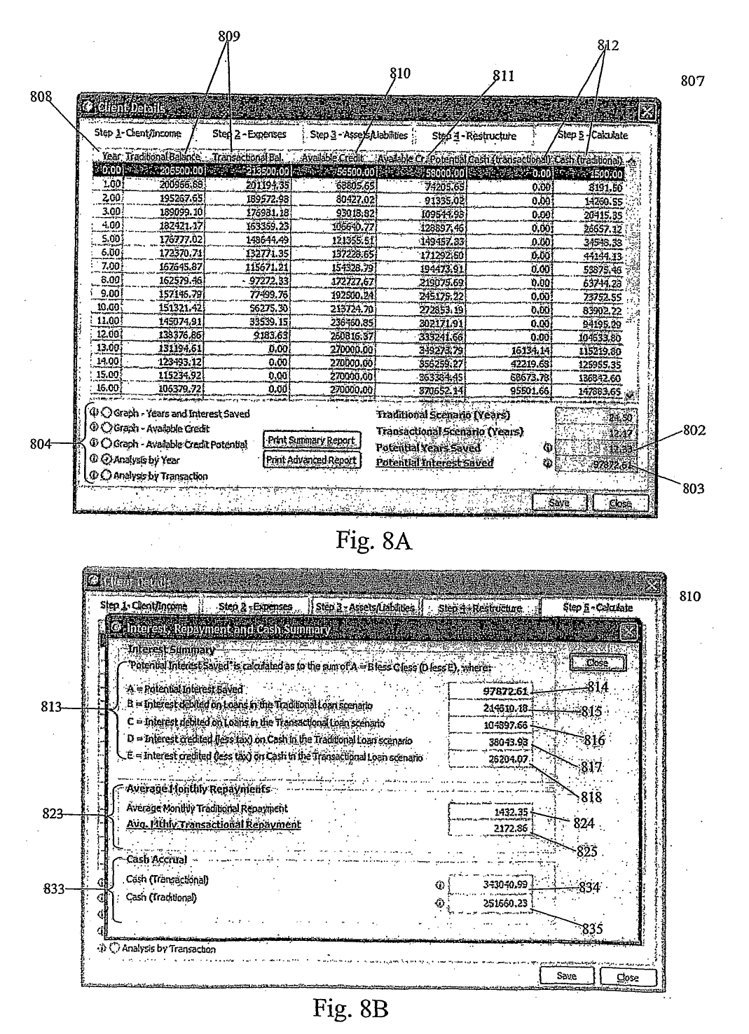

At step 318 of the method in flowchart 300, the loan balance is calculated to simulate repayment on the refinanced basis. A graphical display depicting annual balance of the refinancing transactional home loan against a current ‘Traditional’ home loan account is produced. FIG. 8 illustrates a fifth user interface screen including a simulation display window 800 showing the graphical display of the ‘Loan Comparison’ 801 together with calculated amounts of ‘Interest Saved’ in field 802 and ‘Years Saved’ in field 803 over the respective loan terms. The Loan Comparison includes a bar graph showing a sequence of the annual loan balances of a traditional home loan 805 compared with corresponding balances for a proposed transactional home loan 806.

Radio buttons 804 are also provided for selecting graphs demonstrating ‘Available Credit’ throughout the course of the transactional home loan term, demonstrating ‘Available Credit Potential’ throughout the course of loan term, factoring property price increases or decreases as nominated by the user in ‘Step 4’ (see FIG. 7), a table demonstrating the loan balance and term of the current loan in comparison to the transactional home loan per year, and the available credit per year, and a table demonstrating the loan balance of the transactional loan per transaction until a loan balance of nil is attained.

Window 807 of FIG. 8A depicts such a table, the year 808 is displayed in the far left hand column followed by the balance for each scenario 809, the available credit 810, the available credit potential 811 and the cash accrual 812 for each scenario. The user can freely toggle between the desired interface form 800 or 807 via radio buttons 804.

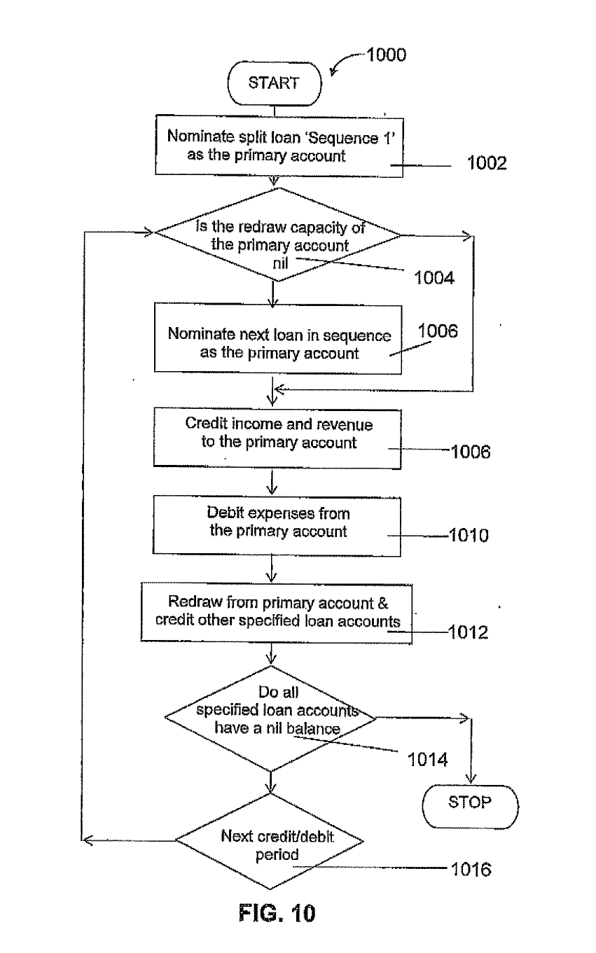

Details of the steps of the simulation are set out in FIG. 10. The simulator program module 1000 conducts the following operations, in step 1002 the “Primary Account” is allocated to the transactional home loan as selected or created by the user in “Step 4—Restructuring” interface auxiliary form 720 as Split Loan Account 1, i.e. sequence 1 in table 703 of FIG. 7A.

Then if in step 1004, the redraw capacity in Split Loan Account 1 is nil, the next nominated Split Loan Account in the payout sequence becomes the “Primary Account”, in step 1006 so forth. Suitably the loans that are designated in the “Step 3—Assets/Liabilities” section of the user interface form 510 (see column 515) that are not “closed” by the user may not be the Primary Account.

In step 1008, income and other revenue is credited into the Primary Account at the beginning of each specified period (ie. weekly, fortnightly, monthly etc.) and in step 1010 expenses are debited from the Primary Account at the beginning of each specified period.

Preferably the income amounts entered into “Tax Refund Diminishing” reduce over the duration of the simulation in ratio to the principal balance of tax-deductible loans and at the income frequency selected by the User; whereas income amounts entered into “Tax Refund Fixed” remains constant over the duration of the simulation. For simplicity other tax refunds are not calculated in the embodiment. Except as modified by the user, income (other than “Tax Refund Diminishing)” and expenses remain constant for the duration of the simulation.

When the Primary Account has a loan balance of nil, the Primary Account is redrawn to a percentage of its redraw capacity as nominated by the user and an amount equal to the amount redrawn from the Primary Account is credited to another loan account as nominated by the user, in step 1012. This process continues for the duration of the simulation until such time that all loan accounts have a loan balance of nil.

When an “Interest-Only” split segment is selected by the User from a Set-up button 506 in the “Step 3—Assets/Liabilities” section of the user interface form 500 (see FIG. 5) or the Product Set-up button in the “Step 4—Restructuring” section as above, it is assumed that the loan relating to the Split Segment is being serviced on an “Interest-Only” basis for the duration of the simulation regardless of any term nominated by the User unless subsequent Split Segments are added. If a subsequent Split Segment is an “Interest-Only” Split Segment, then it shall be also perform in the same manner.

All security in the form of real property “Assets” (i.e. Homes and Investment Properties) that are nominated as “Closed” by the User in the “Step 3—Assets/Liabilities” section of the Simulator are utilised as security for the loans as nominated in the “Step 4—Restructureing” section of the Simulator on a cross-collateralisation basis.

In “Step 4—Restructure”, the effect of the selection of “Rising”, “Flat” or “Falling” by the User means, for the purposes of the simulation:

Rising—Rising Market

a) If a loan has a fixed interest rate, then the interest rate of the loan remains constant for the duration of the simulation; and

b) If a loan has a floating interest rate, then the interest rate of the loan increases by 0.25% at the commencement of each 6-month period until the interest rate has increased by 4.0%. The fully increased interest rate then remains constant for the balance of the simulation.

Flat—Flat Market

The interest rates of all loans remain constant for the duration of the simulation.

Falling—Falling Market

a) If a loan has a fixed interest rate, then the interest rate of the loan remains constant for the duration of the simulation; and

b) If a loan has a floating interest rate, then the interest rate of the loan decreases by 0.25% at the commencement of each 6-month period until the interest rate has decreased by 4.0% or reached a rate of 1%. The fully decreased rate then remains constant for the balance of the simulation.

Finally, the simulation assumes that no further amounts are borrowed by the user.

At step 320 of the method in flowchart 300, reports relating to the graphs and tables calculated in step 318 may be produced for printing. An advanced reporting function which provides for reports setting out selected financial details and analysis will also be available.

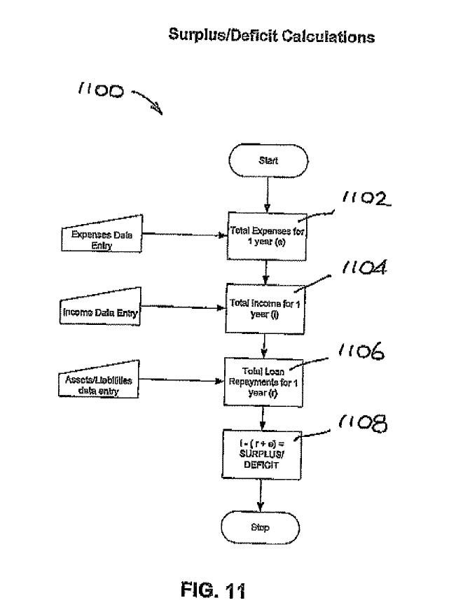

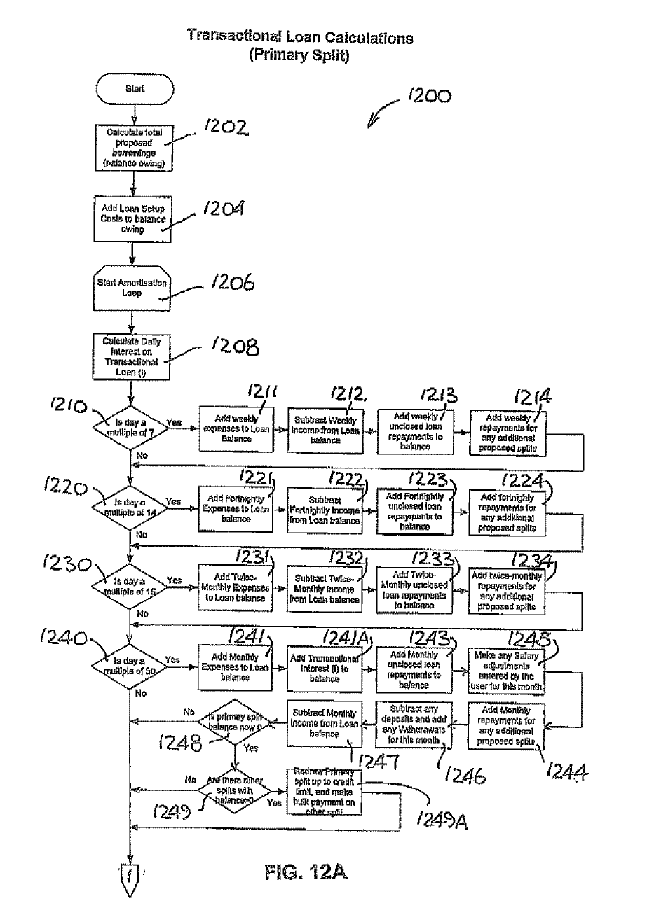

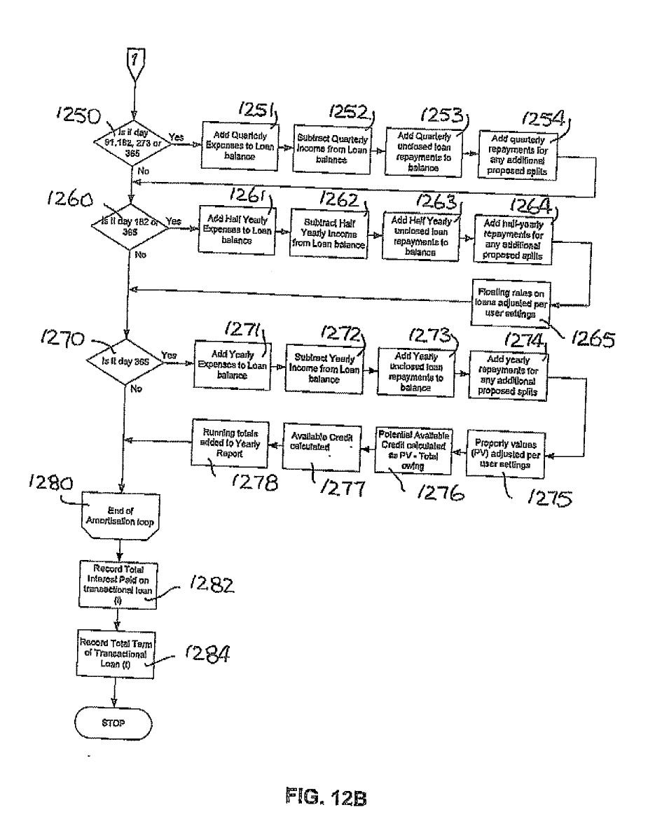

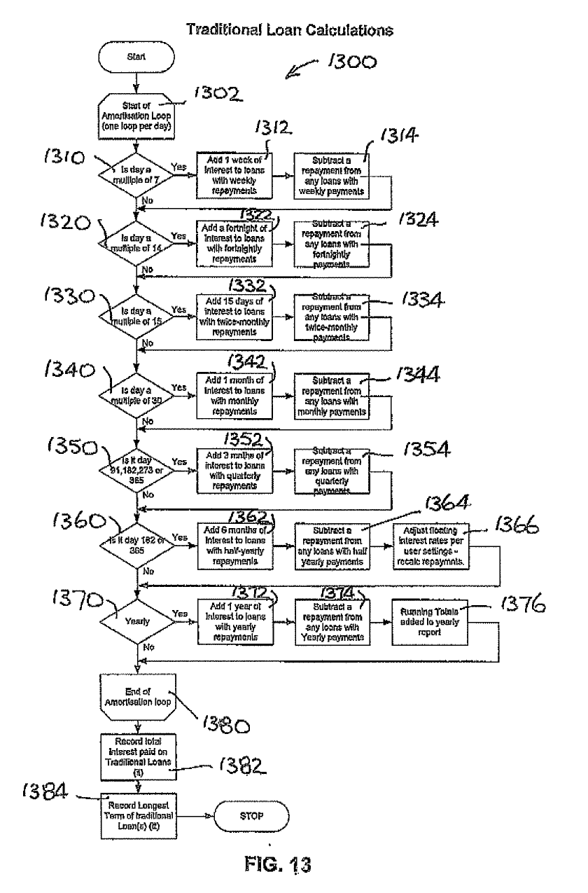

In a further embodiment of the simulation method of the invention, there is provided an initial surplus/deficit calculation procedure, as set out in FIG. 11, together with respective transactional loan and traditional loan calculation procedures, shown in FIGS. 12A/B and FIG. 13 respectively. Although the processing of the traditional loan and the transactional is shown in different flow-charts, they are in fact processed in parallel in the preferred embodiment.

The initial surplus/deficit calculation procedure 1100, which is carried out as part of “Step 3—Assets/Liabilities” (see FIG. 5), involves totalling the expenses for a period of one (1) financial year in step 1102 from the previously entered expense data or input expense information, totalling for the period the income data or information previously entered in step 1104, and totalling the loan repayments data from the input assets and liabilities data in step 1106. The surplus/deficit for the financial year is then calculated in step 1108 by deducting from the total income (i), the sum of the total repayments (r) and the total expenses (e). The interim and final results of this procedure are displayed in windows identified as (i) 560, (r) 561, (e) 562 and “Surplus/Deficit” 663 of the user interface form 500 depicted in FIG. 5.

FIGS. 12A and 12B, when read in sequence together, depict the transactional loan calculation procedure 1200 for a loan proposed to re-finance an existing or current loan (or suite of loans). In step 1202 the total proposed borrowings are calculated from the balance owing on existing loan(s), and the result displayed in window 707 of user interface form 700 (see FIG. 7). The loan setup or establishment costs, previously entered via field 708 of input form 700, are added to the proposed borrowings to determine the total amount required for the proposed transactional loan. The amount of the total loan required is displayed in window 709 of form 700.

The procedure then enters a loan amortisation loop at step 1206, which loop calculates from day incrementing step 1208 the daily interest (i) on the transactional loan for periods of a week, a fortnight, twice-monthly and monthly. This calculation is undertaken by testing in steps 1210, 1220, 1230 and 1240 whether the current day is a multiple of 7, 14, 15 and 30. In each case, and with reference to the weekly case, weekly expenses are added to the loan balance in step 1211, weekly income is subtracted from the loan balance in step 1212, weekly unclosed loan payments are added in step 1213 and weekly repayments for any additional loan splits or portions in step 1214. It will be appreciated that these steps have counterparts in each case (and are denoted by references ending in '#1, '#2, '#3 and '#4).

In the case of monthly expenses following test 1240, there are additional steps including the addition of transactional interest (i) in step 1241A, making salary adjustments entered by the user for the month in step 1245, the subtraction of deposits and addition of withdrawals in step 1246, and the subtraction of monthly income from the loan balance in step 1247. In test step 1248, further processing continues where the primary account (split portion) does not have a nil balance. If the primary account balance is nil, a test for other split portions with nil balance occurs in step 1249. In that case, a redraw is undertaken to make a bulk payment on other splits in step 1249A.

With reference to FIG. 12B, further testing of predetermined days is conducted to identify quarterly, half yearly and annual periods in steps 1250, 1260 and 1270. In the half yearly processing sequence, there is an additional step for adjusting floating interest rates on the loans 1265, as per user settings. Turning to the extra annual processing steps, these include adjusting property values (PV) in step 1275 in accordance with the user setting (of falling flat or rising values), calculating the potential available credit as property values (PV) less total owing in step 1276, calculating available credit in step 1277 and updating running totals for use in an annual report in step 1278.

Further explanation of certain values calculated during processing of the transaction loan in accordance with the further embodiment follow:

Redrawing

When the transactional loan is processed, only the primary split is treated as a transactional loan initially. While the primary split is processing, all other proposed splits are serviced as traditional P&l or I/O loans depending on how they have been set-up. However once the primary split has been paid out, it is then redrawn up to a maximum of its credit limit, and a bulk repayment is made to the second split. This continues until all splits have a balance of zero.

Redrawing of the primary split has been shown to occur only monthly for clarity, however the reality is that a redraw will potentially occur whenever the primary split balance reaches zero—this may be at any time where the balance is credited via either income, or a fixed deposit.

Primary Split Interest

Interest is calculated on the primary split on a daily basis, however is only added to loan balances monthly

Salary Adjustments

The user of the simulation program of the embodiment, may choose to set-up future salary adjustments. For example, if a second income earning borrower (eg. a partner) is to have a year off work to have a child, then salary could be adjusted to zero starting and month n and ending at month n+12.

This also allows the user to anticipate salary increases/decreases if desired. At monthly intervals during the processing of the primary split, the program checks for and makes any salary adjustments that have been entered by the user.

Deposits/Withdrawals

The user can also elect to make a deposit or withdrawal from the primary account at any point in the loan. An example where this might be used is:

Withdrawal: Customer plans to buy a new car in 2 years

Deposit: Investment matures in 5 years

Floating Rates Adjustments

The user may elect to anticipate the future market interest rates. The user may choose Flat, Falling or Rising interest rates. If the user chooses flat interest rates then no floating rate adjustments to loans are necessary. If Falling or Rising is chosen, then Floating rates are adjusted according to the following schedule:

Rising: Rates are increased 0.25% every 6 months until rate is up by 4% on the original rate

Falling: Rates are decreased 0.25% every 6 months until rate is down by 4% or 1% is reached.

The adjustment of interest rates makes it necessary to recalculate repayment amounts on all loans that have Floating rates, and are currently being processed as standard P+I or I/O loans.

Property Value Adjustments

Another means of anticipating future market state provided by the program is the ability to adjust property values annually. This may be set as increasing or decreasing, and the percentage may be chosen.

This only affects the potential available credit calculations, as Potential Available Credit=Property Value (PV)×Maximum LTV (eg 80%)−Total owing on all liability splits.

Available Credit Calculations

Available credit is maintained on a per-split basis. For a given split, it can be calculated at any time to be the following value:
Av=Virtual Loan Balance−Actual Loan Balance

Where Virtual Loan Balance is the balance that the loan would have been at had it been paid out at the rate originally specified in the segment. For I/O segments the initial virtual loan balance is calculated as the Credit limit of the proposed loan(s), and for P+I segments the initial Virtual Loan balance is calculated as the amount actually drawn down.

Step 1280 indicates termination of the amortisation loop involving cases 1210 to 1270, when all loan portions have a nil balance or a period of 35 years has passed in the embodiment. Subsequently, the total interest paid (i tot) on the transactional loan is recorded in step 1282 and the required or total term (t) of the loan is recorded in step 1284.

The calculation process 1300 for the traditional loan is depicted in FIG. 13. It uses a similar daily amortisation loop commencing at step 1302, and terminating at step 1380 under the same conditions described in relation to step 1280 above. Again there is a sequence of case testing steps for each of weekly 1310, fortnightly 1320, twice-monthly 1330, monthly 1340, quarterly 1350, half-yearly 1360 and yearly 1370 periods.

In each case, and with reference to the weekly case, a week of interest is added to the loan balance in step 1312, any weekly repayment is subtracted from the loan balance in step 1314. In the 6 month or half-yearly periods, floating interest rates and adjusted as per user settings and repayments are re-calculated in step 1366. In the yearly processing procedure, running totals are updated in step 1376.

After the amortisation loop terminates at step 1380, the total interest paid (it) on the traditional loan(s) is recorded in step 1382 and the term (tt) of the longest of the traditional loan(s) is recorded in step 1384.

For the purpose of comparison with the transactional loan, the Potential Years saved is calculated as the Term of the longest Traditional loan (tt) minus the Term of the Transactional loan (t). FIG. 8B depicts a summary display window 810 showing the calculation 813 of the Potential Interest Saved 814. The Potential Interest Saved 814 is a function of the Total Interest Paid on Loans in the Traditional scenario 815 minus the Total Interest Paid on Loans in the Transactional scenario 816 minus the Interest credited (less tax) on cash in the Traditional loan scenario 817 minus the Interest credited (less tax) on cash in the Transactional Loan scenario 818. Also shown in FIG. 8B is a comparison 823 between the average monthly repayments between the traditional 824 and transactional 825 scenarios. Finally there is shown a comparison of the cash accrual 833 between the traditional 834 and transactional 835 scenarios. The cash accruals are also detailed in “Analysis by Year” window (described above) shown in FIG. 8A. The results of the above calculation can then be displayed in the windows denoted 802 and 803 provided in user interface form 800 see FIG. 8 and in user interface form 807 see FIG. 8A.

Although the invention has been particularly described in relation to transactional home loan accounts, it will be appreciated that the simulation method and system of the invention will find application in assessing the comparative performance of a variety of other loans, lines of credit and similar finance products that contain fixed interest rate and variable interest rate portions.

It is to be understood that the above embodiments have been provided only by way of exemplification of this invention, and that further modifications and improvements thereto, as would be apparent to persons skilled in the relevant art, are deemed to fall within the broad scope and ambit of the invention as defined in the claims which follow.

TABLE 1A
Website (etracka.com)

| | | |
|---|---|---|
| Home | | etracka is an independent online service, supporting Customer Members |
| | | to responsibly manage their Transactional Home Loans. |
| etracka Strategy | | 5 step description of the etracka loan reduction strategy (including |
| | | diagrams), utilising Transactional Home Loans and Credit Cards. |
| Why etracka | | etracka manages its loan reduction strategy (as described), whereas |
| | | the primary function of banks is to provide loans. |
| | Transactional Home Loan | etracka definition of a Transactional Home Loan and Credit Card. |
| Contact Us | | etracka Pty Ltd contact details and email facilitation. |
| Become a Member | Customer Member | User benefits of the etracka Service only |
| | Loan-Writer Member | User benefits of the etracka Pro and etracka Service operated indepent |
| | | of Lender Members. |
| | Lender Member | Lender benefits (eg. Co-branded etracka Pro and etracka Service |
| | | including Product exclusivity and other special services). |
| Member Logon | Loan-Writer User | The initial Logon by a Loan-Writer User is to download the etracka |
| | | Pro and complete online training (See Below). Logon after the |
| | | Initial Logon displays a Menu of Customer Members for whom the |
| | | Loan-Writer User is authorised (by the Customer Member) to |
| | | assist at the etracka Service. The Loan-writer User may then sort |
| | | and/or select from the Menu and access the etracka Service |
| | | for the Customer Member selected with full functionality excluding |
| | | access to the Customer Member's Administration window. |
| | etracka Service | Logon to the etracka Service (See Table 4). Also includes direct |
| | | registration of Customer Members. |
| | Master Controls | Logon to administration for etracka Master Control (See Table 5), |
| | | etracka Lender and Loan-Writer Controls (See Table 6). |
| etracka Express | | Marketing simulator. It takes less than 2 minutes to complete a |
| | | simulation created from a set of basic assumptions. |
| etracka Service Demo | | Demonstration of the etracka Service. |
| etracka Live Support | | Chat style email service operating 24 hours a day, 7 days a week |
| | | to support Customer Members. |
| Notices | Terms of Use | Terms and Conditions of website use are specified. |
| | Legal Notices | Privacy and Spam statements |
| | Copyright Notice | etracka Pty Ltd 2005. |

TABLE 1B
etracka Pro Download

| | |
|---|---|
| etracka Number | 1. After registration of a Loan-Writer User (“User”), an email with the User's |
| | etracka identification Number and an initial Password is sent with to the User. |
| Initial Logon | 2. In the process of logging on at etracka.com with the etracka Number, the User |
| | changes the Password and agrees to the “Terms & Conditions”. |
| etracka Pro Download | 3. After initial Logon, the etracka Pro is downloaded to the hard drive of the User |
| | (1 time automatic process) together with a User manual. |
| User Training | 4. The User completes an online training module (at etracka.com) based on initial |
| | file data contained on the etracka Pro and information contained at etracka.com. |
| Validation | 5. The User clicks “Sync Link” (on the etracka Pro) to validate the |
| | etracka Pro; thereby gaining full functionality (eg. Ability to create new Client files). |

TABLE 2
etracka Ancillary Functions (etracka Pro and etracka Service)
Ancillary Functions

| | | |
|---|---|---|
| File | Set-Up/Personal Preferences | User Details - Includes the User's details and unique etracka |
| | | Number, enables CRM functions and icons. |
| | | Change Password - Enables the User to change passwords. |
| | Product Assumptions | Lender Member (and generic “Other”) Product Parameters. |
| | Assumptions/Disclaimer | States etracka Simulator Assumptions. |
| | Copyright/Version | Copyright Notice and Simulator Version Number. |
| | Print Basic Report | Print Basic Report function |
| | Print Advanced Report | Print Advanced Report function |
| | Print Basic Report Preview | Print Basic Report Preview function. |
| | Print Advanced Report Preview | Print Advanced Report Preview function. |
| | Print Window | Print Window currently open function |
| | Print Window Preview | Print Window currently open Preview function |
| | Export to Email | Allows files to be sent to etracka help desk for expert analysis |
| | | if a User is having difficulty |
| | Rebuild Data | Maintenance function. |
| | Exit | Exit the etracka Pro. |
| Edit | Insert Today's Date | Date alignment function. |
| Clients | Search | User search of Client files created by a selection of parameter(s). |
| | Recall | Recall of Client files opened in the current session. |
| | New | Create a new Client file. |
| | Delete | Delete a selected Client file. |
| CRM | Maintenance | Allows maintenance of Contacts, Today's Contacts and Letters |
| | | generated |
| Tools | Mortgage/Loan Calculator | Enables the User to calculate repayments and/or loan terms relating |
| | | to “Principal & Interest” and “Interest Only” loans. |
| | Sync Link | Enables the User to register Customer Members to the etracka |
| | | Service (including population of simulation data created by |
| | | the User) by sending proposed customer member data to a Pending |
| | | Tray at Lender to Loan-Writer Control. |
| | Visit Website | Link to etracka.com. |
| | Email for Support | Link to technical support for Loan-Writer Users. |
| | Validation | Allows the User to periodically validate the etracka Pro to |
| | | maintain functionality. |
| | Upgrade/Backup | Link to upgrade download or backup function, which facilitates |
| | | data storage. |
| | Change Default Font Size | Optional viewing function. |

TABLE 3
etracka Pro - Step 1 to 5

| Step 1 - Client/Income | etracka Number | | Unique file number generated automatically upon file creation. |
|---|---|---|---|
| | Entry/Record Create Date | | Creation Date of the Client, which accommodates 2× clients per |
| | | | file, but is expandable. |
| | Client Details | | Title Details, Name Details, Contact Details, Residential/Postal |
| | | | Address Details and Country Details. |
| | Income Set-up | | Changes the data set of Income Details data from any given month |
| | | | to any given month. |
| | Income Details | | After Tax Wage or Salary, Rental Income, Dividends Income, Other |
| | | | Income and Tax Rebate (Diminishing or Fixed) are entered to |
| | | | calculate Annual After Tax Income of each Client and their |
| | | | Combined After Tax Income (ie. All Clients). |
| | Frequency | | For each Income Category, payment tagged as Weekly, Bi-Weekly, |
| | | | Fortnightly, Monthly, Quarterly, ½ Yearly or Yearly |
| | Express Simulator | | Allows optional access to Express Simulator after entering |
| | | | Client Details |
| | Application | | Supplementary application fields and the “Submit Application” |
| | | | function (population of data to Lender Members). |
| Step 2 - Expenses | Expense Items | | Expenses Categories are listed with menu-headers tailored by |
| | | | Country to effect term neutralisation. The User may create |
| | | | additional Categories (and apply a Menu description). |
| | Frequency | | For each Expense Category, payment is identified as Weekly, |
| | | | Bi-Weekly, Fortnightly, Monthly, Quarterly, Half-Yearly or Yearly. |
| | Estimate | | The amount expended on each Expense. Category is entered at the |
| | | | Frequency selected. |
| | Deposits/Withdrawals | | Lump sum Deposits and/or Withdrawals may be included at any |
| | | | given month. |
| | Surplus/Deficit | | The sum of “Total Annual After Tax Income (ie. Step 1)” |
| | | | less the Total Annual Repayments (ie. Step 2) and “Total |
| | | | Annual Expenses (ie. Step 3)”. |
| Step 3 - Assets/Liabilities | Summary Window | | Home(s), Investment Property(s), Other Investment(s), Personal/Other |
| | | | Loan(s), Credit Card(s), Motor Vehicle and Cash/Savings are |
| | | | summarised to display the Total Value of Assets, Total Amount Owing, |
| | | | Total Annual Repayment (in Year 1) and Close status (ie. Identifies |
| | | | whether an Asset and its associated Liabilities are to be included |
| | | | in the simulated refinance). |
| | Set-up - Assets | | Asset Description, Value of Asset, Lender (of any Liability |
| | | | associated with the Asset) and Close status (ie. Identifies whether |
| | | | an Asset and its associated Liabilities are to be included in the |
| | | | simulated refinance). |
| | Set-up - Liability Splits | | Split-Loan Account Description, Amount Owing (ie. In the Split |
| | | | Account) and Purpose (ie. Identifies whether the interest |
| | | | relating to the Split Account is Tax Deductible). |
| | Set-up - Liability | | Loan segments relating to each Split Account including Pay Order |
| | Segments | | (ie. Identifies the order in which Segments are paid) Segment Type |
| | | | (ie. Principle & Interest Fixed or Floating; Interest Only Fixed |
| | | | or Floating), Segment Years/Months, Segment Interest Rate, Amount |
| | | | of Segment Repayment and Frequency of Segment Repayment (eg. Monthly). |
| Step 4 - Market/ | State of the Market | | Assumption made by the User as to whether interest rates wil rise, |
| Restructure | | | remain flat or fall. |
| | | | Assumption made by the User as to whether property prices will |
| | | | increase or decrease and by what annual rate. |
| Product Assumptions | Lender | | Selection from Lender Members (or a generic “Other” category). |
| | Product | | Products of Lender Members or as created by the User (ie. “Other”). |
| | Product % LTV | | Maximum Loan To Value ratio of the Product selected. |
| | Max. Lend | | Maximum Lend calculated as to the “Total Value of Real Estate |
| | | | Assets to be used as security in the refinance” multiplied by |
| | | | the Maximum Loan To Value ratio of the Product Selected. |
| Refinance Summary | Loans to be Paid Out | | As identified in Step 2 (ie. Close). |
| | Loan Establishment Costs | | Assumption made by the User as to the costs associated with the |
| | | | refinance. |
| | Additional Funding | | Any amount required in addition to the “Loans to be Paid Out” |
| | | | and “Loan Establishment Costs”. |
| | Total Loan Required | | Total of “Loans to be Paid Out”, “Loan Establishment Costs” |
| | | | and “Additional Funding”. |
| | Current % LTV | | Current “Loan To Value” ratio calculated as to “Total Loan |
| | | | Required” over the “Total Value of Real Estate Assets to |
| | | | be used as security in the refinance”. |
| | Available Credit | | Available Credit following the refinance calculated as to |
| | | | “Maximum Lend” less the “Total Loan Required”. |
| Combo/Product Set-up | Access from Market | | Peruse and/or amend Split and Split Segment combinations of Lender |
| | | | Member's base Products as set-up by Lender Members at etracka |
| | | | Lender Control (See Table 5) or create a new Combination Loan |
| | | | Structure (ie. “Other”). Split-Loan Account 1 is assumed to |
| | | | be a Transactional Loan (“Primary Account”). When the Primary |
| | | | Account has a loan balance of nil, the Primary Account is fully |
| | | | redrawn to its Credit Limit and an amount equal to the amount |
| | | | redrawn from the Primary Account is credited to another loan account |
| | | | as nominated by the User (ie. Pay Order). This process continues |
| | | | for the duration of the simulation until such time as all loan |
| | | | accounts have a loan balance of Nil. |
| | Rate | | Interest Rate of the base Product selected. |
| | Split Accounts | | Split-Loan Account Description, Credit Limit/Loan Amount, Amount |
| | | | Owing, Debt Allocation (To Split-Loan Accounts), Purpose (ie. |
| | | | Identifies whether the interest relating to each Split Account |
| | | | is Tax Deductible) and Pay Order. |
| | Split Segments | | Pay order of Split-Account Segments relating to each Split-Loan |
| | | | Account including a selection of Base Products, Segment Type (ie. |
| | | | Principle & Interest Fixed or Floating; Interest Only Fixed or |
| | | | Floating), Frequency of Repayment (eg. Monthly), Segment |
| | | | Years/Months and Interest Rate. |
| Step 5 - Calculate | Savings | Interest | Potential Interest Saved plus a graph comparing the Current Loan |
| | | | term against the restructured Loan term. |
| | | Years | Potential Years Saved against Current Loan |

| | | |
|---|---|---|
| | Available Credit | Graph demonstrating Available Credit throughout the course of the |
| | | etracka Stategy Loan term. |
| | Available Credit | Graph demonstrating Available Credit Potential throughout the |
| | Potential | course of the etracka restructured Loan term, factoring property |
| | | price increases or decreases as nominated by the User in Step 4. |
| | Analysis By Year | Table demonstrating the loan balance and term of the Current Loan |
| | | in comparison to the etracka restructured Loan per year; as well |
| | | as the Available Credit per year. |
| | Analysis By Transaction | Table demonstrating the loan balance of the etracka restructured |
| | | Loans per transaction until loan balance is Nil |
| Reports | Basic/Summary Report | Print Basic/Summary Report function |
| | Advanced Report | Print Advanced Report function |

TABLE 4
etracka Service/Simulator - Step 1 to 5

| Step 1 - Client/Income | etracka Number | | The Customer Menber's unique file number. |
|---|---|---|---|
| | Client Details | | Title Details, Name Details, Contact Details, Residential/Postal Address |
| | | | Details and Country Details. |
| | Income Set-up | | Changes the data set of Income Details set from any given month to |
| | | | any given month. |
| | Income Details | | After Tax Wage or Salary, Rental Income, Dividends Income, Other Income |
| | | | and Tax Rebate (Diminishing or Fixed) are entered to calculate Annual After |
| | | | Tax Income of each Client and the Combined After Tax Income (ie. All Clients). |
| | Frequency | | For each Income Category, payment is identified as Weekly, Bi-Weekly, |
| | | | Fortnightly, Monthly, Quarterly, Half-Yearly or Yearly. |
| | Administration | | Enables the Customer Member to deny access to Lender Members, |
| | | | Loan-Writer Members and Loan-Writer Users. |
| Step 2 - Expenses | Expense Items | | Expenses Categories are listed with menu-headers tailored by Country |
| | | | to effect term neutralisation. The User may create additional |
| | | | Categories (and apply a Menu description). |
| | Frequency | | For each Expense Category, payment is identified as Weekly, |
| | | | Bi-Weekly, Fortnightly, Monthly, Quarterly, Half-Yearly or Yearly. |
| | Estimate | | The amount expended on each Expense Category is entered at the |
| | | | Frequency selected. |
| | Deposits/Withdrawals | | Lump sum Deposits and/or Withdrawals may be included at any given |
| | | | month. |
| | Surplus/Deficit | | The sum of “Total Annual After Tax Income (ie. Step 1)” less |
| | | | the “Total Annual Repayments (ie. Step 2) and “Total Annual |
| | | | Expenses (ie. Step 3)”. |
| | Quarterly Buttons | | Expense data captured on the Quarterly Spreadsheets relating to |
| | | | Quarters 1 to 4 is calculated and totalled respective to Frequency |
| | | | to display a comparison between the originally estimated Expense |
| | | | data by clicking the respective Quarter buttons. |
| | Quarterly Spreadsheets | | Self-calculating worksheet enabling actual expense data to be |
| | | | entered and calculated with respect to each Expense Menu item on a |
| | | | cumulative basis from Quarter 1 to Quarter 4. Where no expense data |
| | | | is entered into the line that relates to an Expense Menu item, the |
| | | | originally estimated expense is assumed and noted as “Duplicate”. |
| | | | This function continues after “Quarter 1”, but uses entered |
| | | | Spreadsheet data in priority to any originally estimated data |
| | | | (eg. “Quarter 2” duplicates expense patterns from “Quarter 1”, |
| | | | not from the original estimate). |
| Step 3 - Assets/Liabilities | Summary Window | | Home(s), Investment Property(s), Other Investment(s), Personal/Other |
| | | | Loan(s), Credit Card(s), Motor Vehicle and Cash/Savings are |
| | | | summarised to display the Total Value of Assets, Total Amount Owing, |
| | | | Total Annual Repayment (in Year 1) and Close status (ie. Identifies |
| | | | whether an Asset and its associated Liabilities are to be included |
| | | | in the simulated refinance). |
| | Set-up - Assets | | Asset Description, Value of Asset, Lender (of any Liability |
| | | | associated with the Asset) and Close status (ie. Identifies |
| | | | whether an Asset and its associated Liabilities are to be |
| | | | included in the simulated refinance). |
| | Set-up - Liability Splits | | Split-Loan Account Description, Amount Owing (ie. In the Split |
| | | | Account) and Purpose (ie. Identifies whether the interest |
| | | | relating to the Split Account is Tax Deductible). |
| | Set-up - Liability | | Loan segments relating to each Split Account including Pay Order |
| | Segments | | (ie. Identifies the order in which Segments are paid) Segment Type |
| | | | (ie. Principle & Interest Fixed or Floating; Interest Only Fixed or |
| | | | Floating), Segment Years/Months, Segment Interest Rate, Segment |
| | | | Repayment and Frequency of Segment Repayment (eg. Monthly). |
| Step 4 - Market/ | State of the Market | | Assumption made by the User as to whether interest rates wil rise, |
| Restructure | | | remain flat or fall. |
| | | | Assumption made by the User as to whether property prices will |
| | | | increase or decrease and by what annual rate. |
| Product Assumptions | Lender | | Selection from Lender Members (or a generic “Other” category). |
| | Product | | Products of Lender Members or as created by the User (ie. “Other”). |
| | Product % LTV | | Maximum Loan To Value ratio of the Product selected. |
| | Max. Lend | | Maximum Lend calculated as to the “Total Value of Real Estate |
| | | | Assets to be used as security in the refinance” multiplied by |
| | | | the Maximum Loan To Value ratio of the Product Selected. |
| Refinance Summary | Loans to be Paid Out | | As identified in Step 2 (ie. Close). |
| | Loan Establishment Costs | | Assumption made by the User as to the costs associated with the |
| | | | refinance. |
| | Additional Funding | | Any amount required in addition to the “Loans to be Paid Out” |
| | | | and “Loan Establishment Costs”. |
| | Total Loan Required | | Total of “Loans to be Paid Out”, “Loan Establishment Costs” and |
| | | | “Additional Funding”. |
| | Current % LTV | | Current “Loan To Value” ratio calculated as to “Total Loan |
| | | | Required” over the “Total Value of Real Estate Assets to |
| | | | be used as security in the refinance”. |
| | Available Credit | | Available Credit following the refinance calculated as to |
| | | | “Maximum Lend” less the “Total Loan Required”. |
| Combo Set-up | Access from Market | | Peruse and/or amend Split and Split Segment structures of Lender |
| | | | Member's Combination Products as set-up by Lender Members at |
| | | | etracka Lender Control (See Table 5) or create a new Combination |
| | | | Loan Structure (ie. “Other”). Split-Loan Account 1 is assumed |
| | | | to be a Transactional Loan (“Primary Account”). When the |
| | | | Primary Account has a loan balance of nil, the Primary Account is |
| | | | fully redrawn to its Credit Limit and an amount equal to the amount |
| | | | redrawn from the Primary Account is credited to another loan account |
| | | | as nominated by the User (ie. Pay Order). This process continues for |
| | | | the duration of the simulation until such time as all loan accounts |
| | | | have a loan balance of Nil. |
| | Rate | | Interest Rate of the base Product selected. |
| | Split Accounts | | Split-Loan Account Description, Credit Limit/Loan Amount, Amount |
| | | | Owing, Debt Allocation (To Split-Loan Accounts), Purpose (ie. |
| | | | Identifies whether the interest relating to each Split Account is |
| | | | Tax Deductible) and Pay Order. |
| | Split Segments | | Pay order of Split-Account Segments relating to each Split-Loan |
| | | | Account including a selection of Base Products, Segment Type (ie. |
| | | | Principle & Interest Fixed or Floating; Interest Only Fixed or |
| | | | Floating), Frequency of Repayment (eg. Monthly), Segment Years/ |
| | | | Months and Interest Rate. |
| Step 5 - Calculate | Savings | Interest | Potential Interest Saved plus a graph comparing the Current Loan |
| | | | term against the etracka restructured Loan term. |
| | | Years | Potential Years Saved against Current Loan |

| | | |
|---|---|---|
| | Available Credit | Graph demonstrating Available Credit throughout the course of the |
| | | etracka restructured Loan term. |
| | Available Credit | Graph demonstrating Available Credit Potential throughout the course |
| | Potential | of the etracka restructured Loan term, factoring property price |
| | | increases or decreases as nominated by the User in Step 4. |
| | Analysis By Year | Table demonstrating the loan balance and term of the Current Loan |
| | | in comparison to the etracka restructured Loan per year; as well |
| | | as the Available Credit per year. |
| | Analysis By Transaction | Table demonstrating the loan balance of the etracka restructured |
| | | Loans per transaction until loan balance is Nil. |
| Reports | Basic/Summary Report | Print Basic/Summary Report function |
| | Advanced Report | Print Advanced Report function |

TABLE 5
etracka Master Control

| | | |
|---|---|---|
| System Administrators | Details | Name Details and Contact Details. The Details of the initial |
| (ie. Authorised to operate | | Administrator are created by the Programmer, after which the |
| etracka Master Control) | | initial Administrator may create/set-up new Administrators. |
| | New | Create an Adminstrator. |
| | etracka Number | Administrator's unique file number generated automatically |
| | | upon file creation by the Programmer (Initial Administrator) |
| | | or by an Administrator (thereafter). |
| | Registration/Deregistration | Date of Administrator Registration and Date of Administrator |
| | | Deregistration. |
| Create Lender Member | New | Create a Lender Member (Record Details and generate etracka |
| | | Numbers for the Lender Member and the Initial etracka |
| | | Lender Control Administrator). |
| Create Loan-Writer Member | New | Create a Loan-Writer Member (Record Details and generate etracka |
| | | Numbers for the Loan-Writer Member and the Initial etracka |
| | | Lona-Writer Control Administrator) to include Credit Card Details. |
| etracka Pro and | New | Create or view a Country and it's default settings (for Loan-Writer |
| Service/Simulator | | members) per country. |
| | Country Default Settings | Defaults per country including Phone Characters, Loan Purpose, |
| | | Expense Menus and Terms & Conditions of use for the etracka |
| | | Pro and the etracka Service. |
| | Tool Tips | User Guide and explanatory wording activated by holding the mouse |
| | | over topic headers. |
| | Archive | Access to etracka Pro data created by Loan-Writer Users. |
| etracka.com | Glossary | Wording for the Glossary. |
| | T&C | Wording for the Legal Notice. |
| etracka Express | Set-up | Create or view: (1) Interest rates assigned to the etracka Express |
| | | Simulator (positioned at etracka.com) for Traditional and |
| | | Transactional Loan Products. (2) A Marketing Message (limited to |
| | | a specific number of characters). |
| Reports | Report Generation | Selection of Management Reports relating to Lender Members, |
| | | Loan-Writer Members, Loan-Writer Users, |
| | | Customer Members and Products Selected |
| | Find Functions | Find a Client |
| | | Find a User |

TABLE 6A
etracka Lender Control

| | | |
|---|---|---|
| Lender Member | Details | Name Details, Contact Details, Residential/Postal Address Details, |
| | | Country Details and Website Address Details as created at |
| | | etracka Master Control. |
| | etracka Number | Lender Member's unique file number generated automatically upon |
| | | file creation at etracka Master Control. |
| | Registration/Deregistration | Date of Lender Member Registration and Date of Lender Member |
| | | Deregistration at etracka Master Control. |
| Administrators | Details | Name Details and Contact Details. The Details of the initial |
| (ie. Authorised to operate | | Administrator are created at etracka Master Control, after which the |
| etracka Lender Control) | | initial Administrator may create new Administrators. |
| | New | Create an Adminstrator. |
| | etracka Number | Administrator's unique file number generated automatically upon |
| | | file creation at etracka Master Control (Initial Administrator) or |
| | | by an Administrator (thereafter). |
| | Registration/Deregistration | Date of Administrator Registration and Date of Administrator |
| | | Deregistration. |
| Loan-Writer Users (“Users”) | Details | Name Details and Email Address. |
| | New | Create a User. |
| | etracka Number | User's unique file number generated automatically upon file |
| | | creation by an Administrator. |
| | Registration/Deregistration | Date of User Registration and Date of User Deregistration. |
| | Validation Indicator | Identifies that the User's etracka Pro validation status is |
| | | current. |
| | Training Indicator | Identifies that the User has completed online training. |
| | Assignment Window | Enables Customer Member file assignment from one User to another. |
| Products | Base Product | Create or view “Base Products”, being 1× Split-Loan Account |
| | | with 1× Split Account Segment, assumed as a Transactional Home Loan |
| | | and including Base Product Name, Interest Rate, Redraw Capacity and |
| | | Max. Product % LTV. |
| | Combination Product | Create or view “Combination Products” which may consist of |
| | | Split-Loan Accounts and Split Account Segments made up of Base |
| | | Products and including Product Name, Segment Terms, Segment Types |
| | | (ie. Principle & Interest Fixed or Floating; Interest Only Fixed or |
| | | Floating), Frequency of Repayments (eg. Monthly) and Pay Order of |
| | | Split-Loan Accounts and Split-Account Segments. |
| | Registration/Deregistration | Date of Product Registration and Date of Product Deregistration by |
| | | an Administrator. Deregistered Products remain functional only at |
| | | the etracka Service where in use by existing Customer Members at |
| | | the Date of Product Deregistration. |
| Logo | Set-up | Insert Logo to display at etracka.com, etracka Express (at the |
| | | Lender Member's website), etracka Pro (for Users of the Lender |
| | | Member) and etracka Service/Simulator |
| | Welcome page | Includes a Bulletin Board |
| Reports | Report Generation | Selection of Management Reports relating to Loan-Writer Users, |
| | | Customer Members registered by Loan-Writer Users (and Loan-Writer |
| | | Members for the Lender Member) and Products Selected. |
| | Invoice | Generation of a Report and invoice from etracka Pty Ltd to the |
| | | Lender Member for any given month. |

TABLE 6B
etracka Loan-Writer Control

| | | |
|---|---|---|
| Loan-Writer Member | Details | Name Details, Contact Details, Residential/Postal Address Details, |
| | | Country Details and Website Address Details as created at etracka |
| | | Master Control. |
| | etracka Number | Loan-Writer Member's unique file number generated automatically |
| | | upon file creation at etracka Master. Control. |
| | Registration/Deregistration | Date of Loan-Writer Member Registration and Date of Loan-Writer |
| | | Member Deregistration at etracka Master Control. |
| Administrators | Details | Name Details and Contact Details. The Details of the initial |
| (ie. Authorised to operate | | Administrator are created at etracka Master Control, after which the |
| etracka Loan-Writer Control) | | initial Administrator may create new Administrators. |
| | New | Create an Adminstrator. |
| | etracka Number | Administrator's unique file number generated automatically upon |
| | | file creation by at etracka Master Control (Initial Administrator) |
| | | or by an Administrator (thereafter). |
| | Registration/Deregistration | Date of Administrator Registration and Date of Administrator |
| | | Deregistration. |
| Loan-Writer Users (“Users”) | Details | Name Details and Email Address. |
| | New | Create a User. |
| | etracka Number | User's unique file number generated automatically upon file |
| | | creation by an Administrator. |
| | Registration/Deregistration | Date of User Registration and Date of User Deregistration. |
| | Validation Indicator | Identifies that the User's etracka Pro validation status is current. |
| | Training Indicator | Identifies that the User has completed online training. |
| | Assignment Window | Enables Customer Member file assignment from one User to another. |
| etracka Express | Set-up | Create or view: (1) Interest rates assigned to the etracka Express |
| | | Simulator (positioned at the Loan-Writer Member's website) for |
| | | Traditional and Transactional Loan Products. (2) A Marketing Message |
| | | (limited to a specific number of characters). |
| | Registration/Deregistration | Date of Set-up Registration and Date of Set-up Deregistration by |
| | | an Administrator. |
| Logo | Set-up | Insert Logo to display at the etracka Express positioned at the |
| | | Loan-Writer Member's website. |
| | Welcome page | Includes a Bulletin Board |
| Reports | Report Generation | Selection of Management Reports relating to Loan-Writer Users, |
| | | Customer Members registered by Loan-Writer Users and Products Selected. |

1. A method of simulating for a borrower the performance of a loan, which loan contains a plurality of loan portions wherein each loan portion has different loan parameters, the method comprising:
inputting income information about income of the borrower;
inputting expenditure information about expenditure of the borrower;
inputting asset information and liability information about assets and liabilities of the borrower;
inputting loan parameter information about the amount, interest rate, repayment mode and term of each of said plurality of portions of the loan;
providing assumptions about future market conditions affecting the loan;
calculating a flow of funds available for repayment of each portion of the loan according to the borrower income, the borrower expenditure, the borrower assets and liabilities, and the loan parameter information; and
producing a simulation of loan balance according to the flow of funds and the assumptions about future market conditions.

2. The simulation method of claim 1 wherein each loan portion comprises a plurality of loan segments relating to the temporal sequence of the loan portion, which portion comprises a portion of the amount of said loan.

3. The simulation method of claim 1 wherein inputting income information includes inputting at least one of wage or salary income, rental income, dividend income, tax refunds and the frequency of each income category.

4. The simulation method of claim 1 wherein inputting asset information and liability information includes information about pre-existing loans and repayments relating to the liabilities of the borrower.

5. The simulation method of claim 1 wherein inputting asset information and liability information further includes inputting security information about security provided for the loan.

6. The simulation method of claim 5 wherein the security information includes a valuation of the security over which a mortgage or charge is held to secure the loan.

7. The simulation method of claim 1 wherein inputting loan information includes inputting a lender, type of loan product, the interest rate of the loan product and the maximum loan-to-value (LTV) ratio.

8. The simulation method of claim 7 wherein the type of loan product includes at least one of an interest only/fixed credit limit type and an amortizing credit limit type of loan.

9. The simulation method of claim 1 wherein inputting loan information includes inputting information about a proposed transactional loan for the purposes of comparison.

10. The simulation method of claim 1 wherein inputting loan information comprises a precedent step of setting up portions of the loan and the temporal segments of the loan portions with respective loan parameters.

11. The simulation method of claim 10 wherein setting up said loan portions suitably includes inputting the loan portion amounts, the debt to be allocated to each loan portion and the tax-deductibility treatment of each loan portion.

12. The simulation method of claim 10 wherein setting up the segments of the portions suitably includes inputting the interest rates, indicating whether said interest rates are at least one of fixed and variable interest rates, and inputting the term of each segment of the portion.

13. The simulation method of claim 1 further including calculating the maximum available loan amount on the basis of the total value of security to be used multiplied by the maximum loan-to-value ratio, and displaying said maximum available loan amount to the borrower.

14. The simulation method of claim 1 wherein inputting assumptions about future market conditions affecting the loan includes inputting variations in interest rates applicable to said variable interest rate portions or segments of the loan.

15. The simulation method of claim 1 wherein calculating the flow of funds includes:
a) nominating a desired loan portion as the primary account;
b) nominating the next loan portion in sequence as the primary account if the desired loan portion has a nil redraw capacity;
c) crediting income and revenue to the primary account;
d) debiting expenses from the primary account;
e) redrawing funds from the primary account and crediting other specified loan accounts; and
f) repeating steps b) to e) for next credit/debit period unless all other specified loan accounts have nil balance.

16. The simulation method of claim 15 wherein step c) includes crediting any interest earned on funds held as a cash accrual account which account holds any accumulating surplus cash.

17. The simulation method of claim 1 wherein producing a simulation of the loan balance according to the flow of funds includes displaying to the borrower at least one of:
a graph depicting the loan balance at intervals throughout the term of the loan; and
a table demonstrating the loan balance of the loan per year or per transaction until a loan balance of nil is attained.

18. The simulation method of claim 1 wherein simulating the loan balance includes calculation of loan credit and available loan credit potential.

19. The simulation method of claim 1 for a transactional loan, wherein the simulation includes producing available loan credit according to the flow of funds, which further includes producing a table comparing the loan credit and the loan credit potential available per year for the transactional loan.

20. A method of simulating for a borrower or borrowers the performance of a transactional loan in accordance with a predetermined strategy, which transactional loan comprises multiple fixed interest rate portions and variable interest rate portions and each portion comprises multiple temporal loan segments, the method comprising:
inputting income information about income of the borrower;
inputting expenditure information about expenditure of the borrower;
inputting asset and liability information about assets and liabilities of the borrower, including existing loans and associated repayments relating to the liabilities of the borrower;
inputting transactional loan information proposed for refinancing of existing loans, including amount, interest rate, repayment mode and term of each portion or segment of said transactional loan;
providing assumptions about future market conditions affecting the loans;
calculating a flow of funds available for repayment of each portion of the transactional loan according to the borrower income, the borrower expenditure, the borrower assets and liabilities, and the transactional loan information; and
producing a simulation of interest and years saved by said refinancing including available loan credit and available loan credit potential according to the flow of funds and the assumptions about future market conditions.

21. The simulation method of claim 20 wherein each loan portion comprises a plurality of loan segments relating to the temporal sequence of the loan portion, which portion comprises a portion of the amount of said loan.

22. The simulation method of claim 20 wherein inputting income information includes inputting at least one of wage or salary income, rental income, dividend income, tax refunds and the frequency of each income category.

23. The simulation method of claim 20 wherein inputting asset information and liability information includes information about pre-existing loans and repayments relating to the liabilities of the borrower.

24. The simulation method of claim 20 wherein inputting asset information and liability information further includes inputting security information about security provided for the loan.

25. The simulation method of claim 24 wherein the security information includes a valuation of the security over which a mortgage or charge is held to secure the loan.

26. The simulation method of claim 20 wherein inputting loan information includes inputting a lender, type of loan product, the interest rate of the loan product and the maximum loan-to-value (LTV) ratio.

27. The simulation method of claim 26 wherein the type of loan product includes at least one of an interest only/fixed credit limit type and an amortizing credit limit type of loan.

28. The simulation method of claim 20 wherein inputting loan information includes inputting information about a proposed transactional loan for the purposes of comparison.

29. The simulation method of claim 20 wherein inputting loan information comprises a precedent step of setting up portions of the loan and the temporal segments of the loan portions with respective loan parameters.

30. The simulation method of claim 29 wherein setting up said loan portions suitably includes inputting the loan portion amounts, the debt to be allocated to each loan portion and the tax-deductibility treatment of each loan portion.

31. The simulation method of claim 29 wherein setting up the segments of the portions suitably includes inputting the interest rates, indicating whether said interest rates are at least one of fixed and variable interest rates, and inputting the term of each segment of the portion.

32. The simulation method of claim 20 further including calculating the maximum available loan amount on the basis of the total value of security to be used multiplied by the maximum loan-to-value ratio, and displaying said maximum available loan amount to the borrower.

33. The simulation method of claim 20 wherein inputting assumptions about future market conditions affecting the loan includes inputting variations in interest rates applicable to said variable interest rate portions or segments of the loan.

34. The simulation method of claim 20 wherein calculating the flow of funds includes:
a) nominating a desired loan portion as the primary account;
b) nominating the next loan portion in sequence as the primary account if the desired loan portion has a nil redraw capacity;
c) crediting income and revenue to the primary account;
d) debiting expenses from the primary account;
e) redrawing funds from the primary account and crediting other specified loan accounts; and
f) repeating steps b) to e) for next credit/debit period unless all other specified loan accounts have nil balance.

35. The simulation method of claim 34 wherein step c) includes crediting any interest earned on funds held as a cash accrual account which account holds any accumulating surplus cash.

36. The simulation method of claim 20 wherein producing a simulation of the loan balance according to the flow of funds includes displaying to the borrower at least one of:
a graph depicting the loan balance at intervals throughout the term of the loan; and
a table demonstrating the loan balance of the loan per year or per transaction until a loan balance of nil is attained.

37. A computer readable medium carrying instructions for executing the loan simulation method as claimed in claim 1.

38. An on-line subscriber system enabling users to conduct assessment and ongoing management of loans or similar finance products, said system including:
a service centre accessible via a public communications network, the service centre including processor means for executing a service software application, storage means for storing the service software application and client data, and communications interface means;
and at least one client software application for execution by a remote client device for accessing the service centre via the public communications network;
whereby upon verification of the identity of a Customer Member by the service centre, the client software application and the service centre software application interoperate to implement the method as claimed in claim 1 for simulating for the Customer Member the performance of a loan which contains a plurality of portions having different parameters.

39. A service software application for a service centre of an on-line subscriber system enabling users to conduct assessment and ongoing management of loans or similar finance products, said software application including:
a master control module for administering records of subscribers and for configuration of member interfaces and a customer interface to a customer web site;
a loan-writer member control module for controlling a loan-writer interface in a loan-writer/lender web site;
a lender member control module for controlling a lender interface in the loan-writer/lender web site and a member information store, the lender interface providing access to information in a loan products information store; and
a simulator module for executing a loan simulation method as claimed in claim 1, utilizing loan parameters entered via the member or customer interfaces.
